(19) United States
(12) Patent Application Publication
(10) Pub. No.: US 2024/0422022 A1
(43) Pub. Date: Dec. 19, 2024

(54) RAN NODE FAILURE/RESTART DETECTION AND RESTORATION FOR MULTICAST MBS SESSION

(71) Applicant: Telefonaktiebolaget LM Ericsson (publ), Stockholm (SE)

(72) Inventors: Jie LING, Shanghai (CN); Yong YANG, Kållered (SE); Juying GAN, Shanghai (CN)

(73) Assignee: Telefonaktiebolaget LM Ericsson (publ), Stockholm (SE)

(21) Appl. No.: 18/706,381

(22) PCT Filed: Dec. 29, 2022
(86) PCT No.: PCT/CN2022/143399

§ 371 Date: Apr. 30, 2024

(30) Foreign Application Priority Data
Dec. 31, 2021 (WO) PCT/CN2021/143933
Jan. 14, 2022 (WO) PCT/CN2022/072074

(51) Int. Cl. H04L 12/18; H04W 24/04; H04W 72/30

(52) U.S. Cl. CPC H04L 12/1868; H04L 12/185; H04W 24/04; H04W 72/30

(57) ABSTRACT

The disclosure is related to network nodes, a RAN node, and methods for detecting a failure/restart of the RAN node and methods for restoring a multicast session. The method at an SMF for detecting a failure and/or restart of a RAN node that serves one or more UEs for a multicast session comprises: receiving, from a network node, a message indicating a failure and/or restart of the RAN node.

### CROSS-REFERENCE TO RELATED APPLICATION(S)

This application claims priority to the PCT International Application No. PCT/CN2021/143933, entitled “NETWORK NODES AND METHODS THEREIN FOR FACILITATING MANAGEMENT OF MULTICAST/BROADCAST SERVICE SESSION”, filed on Dec. 31, 2021, and to the PCT International Application No. PCT/CN2022/072074, entitled “RAN NODE FAILURE/RESTART DETECTION AND RESTORATION FOR MULTICAST MBS SESSION”, filed on Jan. 14, 2022, which are incorporated herein by reference in their entireties.

### TECHNICAL FIELD

The present disclosure is related to the field of telecommunications, and in particular, to network nodes, a Radio Access Network (RAN) node, and methods for RAN node failure/restart detection and restoration for multicast Multicast/Broadcast Service (MBS) session.

### BACKGROUND

Broadcast services, with a scheduled programming, constitute a paramount telecommunication service for today's society. Broadcast is a transport technology to deliver the same content to an unlimited number of devices with a defined quality of service, without increasing substantially network capacity requirements, energy consumption, or costs. Cellular systems are commonly used for unicast transmissions. In this mode, a dedicated channel is established with each UE. In scenarios with a large number of users or devices consuming the same data, the use of broadcast or multicast transmission can offer substantial capacity gains, ensuring a cost-effective and high-quality delivery mechanism.

At unicast transmission, required radio resources grow linearly with the number of UEs receiving the same data. Resource allocation efficiency is improved by simultaneous transmission of data to a set of users. Via broadcast services, all users receive the same information within the service area. In multicast services, users have to subscribe to the specific service before they can receive the information. While broadcast communication is unidirectional, multicast users can establish a return channel allowing interactivity with the network. This return channel can also be used to subscribe to the desired service.

Although the existing technology is mature, current broadcast systems have serious limitations when providing service to moving users or users located in areas with complex orography and poor signal quality. To overcome these limitations, 3rd Generation Partnership Project (3GPP) 5G standard has included a work item to support 5G multicast/broadcast services for Release 17. This will bring the wide flexibility and efficiency of 5G networks to broadcasting services to greatly improve user experience while reducing operational costs. In addition, 5G broadcast/multicast services can complement conventional broadcasting technology which has severe deficiencies in some scenarios like mobility or users in remote areas.

### SUMMARY

According to a first aspect of the present disclosure, a method at a Session Management Function (SMF) for restoring a multicast session for one or more UEs that are served by a RAN node experienced a failure and/or restart is provided. The method comprises: receiving, from a network node, a message indicating a RAN node failure and/or a restart of the RAN node; determining the one or more UEs that joined a multicast session and that are impacted by the failure and/or restart of the RAN node; and triggering establishing relevant resource in the RAN node via an Access and Mobility Management Function (AMF) to receive multicast session data either from a UPF for individual delivery or from a Multicast-Broadcast User Plane Function (MB-UPF) for shared delivery, to restore the multicast session for the impacted one or more UEs, in response to detecting the failure and/or restart of the RAN node.

In some embodiments, the network node comprises at least one of: an Access & Mobility Management Function (AMF); a User Plane Function (UPF); and a Multicast/Broadcast Session Management Function (MB-SMF). In some embodiments, the message comprises at least one of: an Nsmf_PDUSession_UpdateSMContext request message that is transmitted from an AMF for a Protocol Data Unit (PDU) session associated with one of the UEs; a first message for one or more UEs and/or one or more PDU sessions, the first message being a request message transmitted from an AMF for requesting for a service operation provided by the SMF that is not defined in the 3rd Generation Partnership Project (3GPP) Technical Specification (TS) 23.502, V17.3.0 or any of its prior releases; a second message for a list of one or more UEs and/or a list of one or more PDU sessions, the second message being an event notifying message from an AMF for notifying the SMF of an event of a failure and/or restart of the RAN node; a third message for a PDU session, the third message being a session report message from a UPF for reporting the failure and/or restart of the RAN node; a fourth message for a node level event, the fourth message being a node report message from a UPF for reporting the failure and/or restart of the RAN node; and a fifth message for the multicast session, the fifth message being transmitted from an MB-SMF associated with the multicast session.

In some embodiments, the first message indicates one of: a single UE and/or a single PDU session that are impacted by the failure and/or restart of the RAN node; and a list of one or more UEs and/or a list of one or more PDU sessions that are impacted by the failure and/or restart of the RAN node. In some embodiments, the second message indicates one of: a Communication-Failure-Report event; and an AMF event that is not defined in the 3GPP TS 23.502, V17.3.0 or any of its prior releases or 3GPP TS 29.518 V17.4.0 or any of its prior releases. In some embodiments, when the message comprises the second message, the method further comprises, before the step of receiving the message: transmitting, to the AMF, a message for subscribing the event. In some embodiments, the message for subscribing the event comprises at least one of: Identifiers (IDs) of one or more of the UEs or an “any UE” indication; one or more area identifiers; Network Function (NF) service consumer service instance ID; and authority of resource Uniform Resource Identifier (URI). In some embodiments, the event comprises at least one of: a RAN/Non-Access Stratum (NAS) release code; one or more UE IDs; one or more PDU session IDs; and an NG-RAN restart or failure indication.

In some embodiments, the third message is a Packet Forwarding Control Protocol (PFCP) session report message comprising a Tunnel Endpoint ID (TEID) and an Internet Protocol (IP) address pertaining to the failed RAN node. In some embodiments, the fourth message is a PFCP node report message comprising an IP address pertaining to the failed RAN node. In some embodiments, the fifth message is an Nmbsmf_MBSSession_ContextStatusNotify message comprising an indicator indicating the failure and/or restart of the RAN node and/or an ID of the RAN node.

According to a second aspect of the present disclosure, a method at an SMF for restoring a multicast session for one or more UEs that are served by a RAN node experienced a failure and/or restart is provided. The method comprises: triggering establishing relevant resource in the RAN node to receive multicast session data either from a UPF for individual delivery or from a Multicast-Broadcast User Plane Function (MB-UPF) for shared delivery, to restore the multicast session for at least one of the one or more UEs, in response to detecting the failure and/or restart of the RAN node.

In some embodiments, the step of triggering establishing the relevant resource in the RAN node comprises: transmitting, to the RAN node via the AMF, a sixth message to cause the RAN node to initiate the establishment of the relevant resource for the multicast session. In some embodiments, the sixth message comprises an indicator indicating the failure and/or restart of the RAN node and/or an ID of the RAN node. In some embodiments, before the step of triggering establishing the relevant resource in the RAN node, the method further comprises: determining the one or more UEs that joined the multicast session and that are impacted by the failure and/or restart of the RAN node. In some embodiments, the step of determining the one or more UEs comprises at least one of: determining the one or more UEs that are indicated in a received message from the AMF, the received message further indicating the failure and/or restart of the RAN node; and retrieving one or more UEs which have the same IP address in their tunnel endpoint for the downlink tunnel in the RAN node to receive multicast session data when the RAN failure or restart is reported by the UPF.

In some embodiments, the method further comprises: transmitting, to an AMF, a request message to request the AMF to page the one or more UEs to bring these UEs into CM-CONNECTED mode, the request message comprising an indicator indicating the failure and/or restart of the RAN node; and receiving, from the AMF, a response message for indicating which of the one or more UEs is or are in CM-CONNECTED mode. In some embodiments, before the step of triggering establishing the relevant resource in the RAN node, the method further comprises: receiving, from an MB-SMF, a fifth message indicating a detected failure and/or restart of the RAN node and an ID of the RAN node; transmitting, to a Network Repository Function (NRF), a request message to discover a list of AMFs having association with the RAN node; receiving, from the NRF, a response message containing a list of AMFs; selecting an AMF from the list of AMFs; transmitting, to the AMF, a request message for querying the one or more UEs that are impacted by the failure and/or restart of the RAN node and/or for requesting AMF to page the one or more UEs, the request message comprising an indicator indicating the failure and/or restart of the RAN node and/or an ID of the RAN node; and receiving, from the AMF, a response message comprising the one or more UEs and/or acceptance of paging. In some embodiments, the failure and/or restart of the RAN node is detected by the SMF with the method of any of the first aspect.

According to a third aspect of the present disclosure, a first network node is provided. The first network node comprises: a processor; a memory storing instructions which, when executed by the processor, cause the processor to perform the method of any of the first aspect or the second aspect. In some embodiments, the first network node comprises an SMF.

According to a fourth aspect of the present disclosure, a first network node is provided. The first network node comprises: a receiving module configured to receive, from a network node, a message indicating a failure and/or restart of the RAN node. Additionally or alternatively, the first network node comprises: a triggering module configured to trigger establishing relevant resource in the RAN node to receive multicast session data either from a UPF for individual delivery or from an MB-UPF for shared delivery, to restore the multicast session for at least one of the one or more UEs, in response to detecting the failure and/or restart of the RAN node.

According to a fifth aspect of the present disclosure, a method at an AMF for facilitating a network node in detecting a failure and/or restart of a RAN node that serves one or more UEs for a multicast session is provided. The method comprises: receiving, from the RAN node, a seventh message reporting a failure and/or restart of the RAN node; and transmitting, to the network node, a message indicating the failure and/or restart of the RAN node in response to the received seventh message.

In some embodiments, the network node comprises at least one of: an SMF; and an MB-SMF. In some embodiments, the message comprises at least one of: an Nmbsmf_MBSSession_ContextUpdate request message that is transmitted to an MB-SMF for the multicast session; an Nsmf_PDUSession_UpdateSMContext request message that is transmitted to an SMF for a PDU session associated with one of the UEs; a first message for one or more UEs and/or one or more PDU sessions, the first message being a request message transmitted to an SMF for requesting for a service operation provided by the SMF that is not defined in the 3GPP TS 23.502, V17.3.0 or any of its prior releases; and a second message for a list of one or more UEs and/or a list of one or more PDU sessions, the second message being an event notifying message from the AMF to an SMF for notifying the SMF of a failure and/or restart event of the RAN node.

In some embodiments, the Nmbsmf_MBSSession_ContextUpdate request message indicates at least one of: an ID of the multicast session; and an ID of the RAN node that experienced a restart and/or failure. In some embodiments, the first message indicates one of: a single UE and/or a single PDU session that are impacted by the failure and/or restart of the RAN node; and a list of one or more UEs and/or a list of one or more PDU sessions that are impacted by the failure and/or restart of the RAN node. In some embodiments, the second message indicates one of: a Communication-Failure-Report event; and an AMF event that is not defined in the 3GPP TS 23.502, V17.3.0 or any of its prior releases or 3GPP TS 29.518 V17.4.0 or any of its prior releases. In some embodiments, when the message comprises the second message, the method further comprises, before the step of transmitting the message: receiving, from the SMF, a message for subscribing the event, wherein before the step of transmitting the message, the method further comprises: determining the SMF as a destination, which is to be notified of the event, at least based on the received message for subscribing the event.

In some embodiments, the message for subscribing the event comprises at least one of: IDs of the one or more UEs or an “any UE” indication; one or more area identifiers; NF service consumer service instance Id; and authority of resource URI. In some embodiments, the event comprises at least one of: a RAN/NAS release code; one or more UE IDs; one or more PDU session IDs; and an NG-RAN restart or failure indication. In some embodiments, the seventh message comprises at least one of: an NG Setup request message; and an NG Reset request message.

In some embodiments, before the step of receiving the seventh message, the method further comprises: receiving, from the RAN node, an eighth request message requesting for establishing shared delivery toward the RAN node for the multicast session, the eighth request message comprising an N2 container, the N2 container comprising an ID of the RAN node that experienced a failure and/or restart and further comprising a transport IP address when multicast transport is used or an N3mb tunnel endpoint information when unicast transport is used; and transmitting, to the MB-SMF, a ninth request message requesting for establishing shared delivery toward the RAN node for the multicast session at least based on the eighth request message, the ninth request message comprising the ID of the RAN node that is inserted by the AMF and the N2 container; receiving, from the MB-SMF, a ninth response message indicating whether the shared delivery is established successfully or not and/or indicating information for establishing the shared delivery; and transmitting, to the RAN node, an eighth response message indicating whether the shared delivery is established successfully or not and/or indicating information for establishing the shared delivery at least based on the ninth response message.

In some embodiments, the eighth request message is an N2 MBS Session request message, the eighth response message is an N2 MBS Session response message, the ninth request message is an Nmbsmf_MBSSession_ContextUpdate request message, and the ninth response message is an Nmbsmf_MBSSession_ContextUpdate response message.

According to a sixth aspect of the present disclosure, a method at an AMF for facilitating an SMF in restoring a multicast session for one or more UEs that are served by a RAN node experienced a failure and/or restart is provided. The method comprises: forwarding a sixth message from the SMF to the RAN node to cause the RAN node to establish relevant resource for receiving multicast session data either from a UPF for individual delivery or from an MB-UPF for shared delivery, to restore the multicast session for at least one of the one or more UEs.

In some embodiments, the sixth message comprises an indicator indicating the failure and/or restart of the RAN node and/or an ID of the RAN node. In some embodiments, before the step of forwarding the sixth message, the method further comprises: receiving, from the SMF, a request message to request the AMF to page the one or more UEs to bring these UEs into CM-CONNECTED mode, the request message comprising an indicator indicating the failure and/or restart of the RAN node; performing a paging procedure for the one or more UEs; and transmitting, to the SMF, a response message for indicating which of the one or more UEs is or are in CM-CONNECTED mode at least based on the result of the paging procedure. In some embodiments, before the step of forwarding the sixth message, the method further comprises: receiving, from the SMF, a request message for querying the one or more UEs that are impacted by the failure and/or restart of the RAN node and/or for requesting the AMF to page the one or more UEs, the request message comprising an indicator indicating the failure and/or restart of the RAN node and/or an ID of the RAN node; determining the one or more UEs at least based on the ID of the RAN node; performing a paging procedure for the determined one or more UEs; and transmitting, to the SMF, a response message comprising the one or more UEs and/or acceptance of paging at least based on the result of the paging procedure.

According to a seventh aspect of the present disclosure, a second network node is provided. The second network node comprises: a processor; a memory storing instructions which, when executed by the processor, cause the processor to perform the method of any of the fifth aspect or the sixth aspect. In some embodiments, the second network node comprises an AMF.

According to an eighth aspect of the present disclosure, a second network node is provided. The second network node comprises: a receiving module configured to receive, from the RAN node, a seventh message reporting a failure and/or restart of the RAN node; and a transmitting module configured to transmit, to the network node, a message indicating the failure and/or restart of the RAN node in response to the received seventh message. Additionally or alternatively, the second network node comprises: a forwarding module configured to forward a sixth message from the SMF to the RAN node to cause the RAN node to establish relevant resource for receiving multicast session data either from a UPF for individual delivery or from an MB-UPF for shared delivery, to restore the multicast session for at least one of the one or more UEs. In some embodiments,

According to a ninth aspect of the present disclosure, a method at an MB-SMF for restoring a multicast session for one or more UEs that are served by a RAN node experienced a failure and/or restart is provided. The method comprises: receiving, from a network node, a message indicating a failure and/or restart of the RAN node; and triggering establishing relevant resource in the RAN node to receive multicast session data from an MB-UPF for shared delivery, to restore the multicast session for at least one of the one or more UEs, in response to receiving the message indicating the failure and/or restart of the RAN node.

In some embodiments, the network node comprises at least one of: an AMF; and an MB-UPF. In some embodiments, the message comprises at least one of: an Nmbsmf_MBSSession_ContextUpdate request message that is transmitted from an AMF for the multicast session; a tenth message for the multicast session, the tenth message being a session report message from an MB-UPF for reporting the failure and/or restart of the RAN node; and an eleventh message for a node level event, the eleventh message being a node report message from an MB-UPF for reporting the failure and/or restart of the RAN node. In some embodiments, the Nmbsmf_MBSSession_ContextUpdate request message indicates at least one of: an ID of the multicast session; and an ID of the RAN node that experienced a restart and/or failure. In some embodiments, the tenth message is a PFCP session report message indicating a TEID and/or an IP address of the RAN node. In some embodiments, the tenth message is a PFCP node report message comprising an IP address pertaining to the failed RAN node.

In some embodiments, before the step of receiving the message, the method further comprises: receiving, from the AMF, a ninth request message requesting for establishing shared delivery toward the RAN node for the multicast session, the ninth request message comprising an ID of the RAN node that is inserted by the AMF and an N2 container provided by the RAN node, the N2 container comprising the ID of the RAN node and further comprising a transport IP address when multicast transport is used or an N3mb tunnel endpoint information when unicast transport is used; configuring the MB-UPF with the transport IP address when multicast transport is used or the N3mb tunnel endpoint information when unicast transport is used, such that the MB-UPF is able to use the transport IP address or the IP address within the N3mb tunnel endpoint indicated by the N3mb tunnel endpoint information to probe the liveness of the RAN node; storing the AMF in a context for the multicast session; and transmitting, to the AMF, a ninth response message indicating whether the shared delivery is established successfully or not and/or indicating information for establishing the shared delivery at least based on a result of the configuring of the MB-UPF.

In some embodiments, after receiving the ninth request message, the method further comprises: establishing a mapping between the ID of the RAN node and a tunnel to the RAN node for the multicast session. In some embodiments, after the step of receiving the message, the method further comprises: determining the tunnel that is impacted by the failure and/or restart of the RAN node at least based on the mapping between the ID of the RAN node and the tunnel; and transmitting, to the MB-UPF, a message for releasing the tunnel.

In some embodiments, the ninth request message is an Nmbsmf_MBSSession_ContextUpdate request message, and the ninth response message is an Nmbsmf_MBSSession_ContextUpdate response message.

According to a tenth aspect of the present disclosure, a method at an MB-SMF for restoring a multicast session for one or more UEs that are served by a RAN node experienced a failure and/or restart is provided. The method comprises: triggering establishing relevant resource in the RAN node to receive multicast session data from an MB-UPF for shared delivery, to restore the multicast session for at least one of the one or more UEs, in response to detecting the failure and/or restart of the RAN node.

In some embodiments, the step of triggering the one or more tunnels to be established comprises: transmitting, to an SMF that is associated with the RAN node for the multicast session, a notification message to notify the SMF of the failure and/or restart of the RAN node. In some embodiments, the notification message comprises at least one of: an ID of the RAN node; and an indication of the failure and/or restart of the RAN node. In some embodiments, the failure and/or restart of the RAN node is detected by the MB-SMF with the method of any of the ninth aspect.

According to an eleventh aspect of the present disclosure, a third network node is provided. The third network node comprises: a processor; a memory storing instructions which, when executed by the processor, cause the processor to perform the method of any of the ninth or tenth aspect. In some embodiments, the third network node comprises an MB-SMF.

According to a twelfth aspect of the present disclosure, a third network node is provided. The third network node comprises: a receiving module configured to receive, from a network node, a message indicating a failure and/or restart of the RAN node. Additionally or alternatively, the third network node comprises: a triggering module configured to trigger establishing relevant resource in the RAN node to receive multicast session data from an MB-UPF for shared delivery, to restore the multicast session for at least one of the one or more UEs, in response to detecting the failure and/or restart of the RAN node.

According to a thirteenth aspect of the present disclosure, a method at a RAN node for facilitating a network node in detecting a failure and/or restart of the RAN node that serves one or more UEs for a multicast session is provided. The method comprises: transmitting, to the network node, a seventh message reporting a failure and/or restart of the RAN node.

In some embodiments, the network node is an AMF. In some embodiments, the seventh message comprises at least one of: an NG Setup request message; and an NG Reset request message. In some embodiments, before the step of receiving the seventh message, the method further comprises: transmitting, to the AMF, an eighth request message requesting for establishing shared delivery toward the RAN node for the multicast session; and receiving, from the AMF, an eighth response message indicating whether the shared delivery is established successfully or not and/or indicating information for establishing the shared delivery. In some embodiments, the method further comprises: joining the multicast transport distribution for the multicast session by using the received information in the eighth response message. In some embodiments, the eighth request message comprises an ID of the RAN node. In some embodiments, the eighth request message is an N2 MBS Session request message, and the eighth response message is an N2 MBS Session response message.

According to a fourteenth aspect of the present disclosure, a RAN node is provided. The RAN node comprises: a processor; a memory storing instructions which, when executed by the processor, cause the processor to perform the method of any of the thirteenth aspect.

According to a fifteenth aspect of the present disclosure, a RAN node is provided. The RAN node comprises: a transmitting module configured to transmit, to the network node, a seventh message reporting a failure and/or restart of the RAN node.

According to a sixteenth aspect of the present disclosure, a computer program comprising instructions which, when executed by at least one processor, cause the at least one processor to carry out the method of any of the first, second, fifth, sixth, ninth, tenth, and thirteenth aspects.

According to a seventeenth aspect of the present disclosure, a carrier containing the computer program of the sixteenth aspect. In some embodiments, the carrier is one of an electronic signal, optical signal, radio signal, or computer readable storage medium.

According to an eighteenth aspect of the present disclosure, a telecommunication system for maintaining a multicast session is provided. The telecommunication system comprises: a first network node of the third or fourth aspect; a second network node of the seventh or eighth aspect; a third network node of the eleventh or twelfth aspect; and a RAN node of the fourteenth or fifteenth aspect.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating exemplary delivery methods for an MBS session for which RAN node failure/restart detection and/or restoration according to some embodiments of the present disclosure is applicable.

FIG. 2 is a diagram illustrating an exemplary telecommunication network in which RAN node failure/restart detection and/or restoration according to some embodiments of the present disclosure is applicable.

FIG. 3 is a diagram illustrating another exemplary telecommunication network in which RAN node failure/restart detection and/or restoration according to some embodiments of the present disclosure is applicable.

FIG. 4 is a diagram illustrating exemplary user plane data transmission in which RAN node failure/restart detection and/or restoration according to some embodiments of the present disclosure is applicable.

FIG. 5A and FIG. 5B are diagrams illustrating an exemplary procedure for UE joining multicast session, in which RAN node failure/restart detection and/or restoration according to some embodiments of the present disclosure is applicable.

FIG. 6 is a diagram illustrating an exemplary procedure for establishing share delivery toward NG-RAN node, in which RAN node failure/restart detection and/or restoration according to some embodiments of the present disclosure is applicable.

FIG. 7A and FIG. 7B are diagrams illustrating an exemplary MBS session activation procedure in which RAN node failure/restart detection and/or restoration according to some embodiments of the present disclosure is applicable.

FIG. 8 is a diagram illustrating an exemplary procedure for GTP-U error indication from 5G-AN, in which RAN node failure/restart detection and/or restoration according to some embodiments of the present disclosure is applicable.

FIG. 9 is a diagram illustrating an exemplary NG RESET procedure and an exemplary NG SETUP procedure in which RAN node failure/restart detection and/or restoration according to some embodiments of the present disclosure is applicable.

FIG. 10 is a diagram illustrating an exemplary procedure for establishing share delivery toward NG-RAN node according to some embodiments of the present disclosure.

FIG. 11 is a diagram illustrating multiple exemplary methods for detecting a failure and/or restart of a RAN node in CP according to some embodiments of the present disclosure.

FIG. 12 is a diagram illustrating multiple exemplary methods for detecting a failure and/or restart of a RAN node in UP according to some embodiments of the present disclosure.

FIG. 13 is a diagram illustrating an exemplary procedure for SMF initiated multicast MBS session restoration according to some embodiments of the present disclosure.

FIG. 14 is a diagram illustrating an exemplary procedure for MB-SMF initiated multicast MBS session restoration according to some embodiments of the present disclosure.

FIG. 15 is a flow chart of an exemplary method at an SMF for detecting a failure and/or restart of a RAN node according to an embodiment of the present disclosure.

FIG. 16 is a flow chart of an exemplary method at an SMF for restoring a multicast session for one or more UEs according to an embodiment of the present disclosure.

FIG. 17 is a flow chart of an exemplary method at an AMF for facilitating a network node in detecting a failure and/or restart of a RAN node according to an embodiment of the present disclosure.

FIG. 18 is a flow chart of an exemplary method at an AMF for facilitating an SMF in restoring a multicast session for one or more UEs according to an embodiment of the present disclosure.

FIG. 19 is a flow chart of an exemplary method at an MB-SMF for detecting a failure and/or restart of a RAN node according to an embodiment of the present disclosure.

FIG. 20 is a flow chart of an exemplary method at an MB-SMF for restoring a multicast session for one or more UEs according to an embodiment of the present disclosure.

FIG. 21 is a flow chart of an exemplary method at a RAN node for facilitating a network node in detecting a failure and/or restart of a RAN node according to an embodiment of the present disclosure.

FIG. 22 schematically shows an embodiment of an arrangement which may be used in a network node and/or a UE according to an embodiment of the present disclosure.

FIG. 23 is a block diagram of an exemplary first network node according to an embodiment of the present disclosure.

FIG. 24 is a block diagram of an exemplary second network node according to an embodiment of the present disclosure.

FIG. 25 is a block diagram of an exemplary third network node according to an embodiment of the present disclosure.

FIG. 26 is a block diagram of an exemplary RAN node according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (5G NR), the present disclosure is not limited thereto. In fact, as long as RAN node failure and/or restart detection and/or multicast session restoration are involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “network node” used herein may refer to or comprise a base station, a base transceiver station, an access point, a hot spot, a NodeB (NB), an evolved NodeB (eNB), a gNB, a network element, a network function, or any other equivalents.

Further, following documents are incorporated herein by reference in their entireties:
3GPP TS 23.007 V17.2.0 (2021-09), 3rd Generation Partnership Project; Technical Specification Group Core Network and Terminals; Restoration procedures; (Release 17);
3GPP TS 23.247 V17.1.0 (2021-12), 3rd Generation Partnership Project; Technical Specification Group Services and System Aspects; Architectural enhancements for 5G multicast-broadcast services; Stage 2 (Release 17);
3GPP TS 23.527 V17.1.0 (2021-06), 3rd Generation Partnership Project; Technical Specification Group Core Network and Terminals; 5G System; Restoration Procedures (Release 17);
3GPP TS 38.413 V16.8.0 (2021-12), 3rd Generation Partnership Project; Technical Specification Group Radio Access Network; NG-RAN; NG Application Protocol (NGAP) (Release 16); and
IETF Request for Comments (RFC) 4960 Sep. 2007, Stream Control Transmission Protocol.

As defined in 3GPP TS 23.247 v17.1.0, the term “Multicast MBS session” refers to an MBS session to deliver the multicast communication service. A multicast MBS session is characterised by the content to send, by the list of UEs that may receive the service and optionally by a multicast area where to distribute it.

3GPP TS 23.247 v17.1.0 specifies architectural enhancements to the 5G system (5GS) using NR to support multicast and broadcast communication services. To be specific, 3GPP TS 23.247 v17.1.0 specifies the following.

### Overview of Multicast and Broadcast Communication

Multicast and Broadcast Service (MBS) is a point-to-multipoint service in which data is transmitted from a single source entity to multiple recipients, either to all users in a broadcast service area, or to users in a multicast group as defined in TS 22.146.

The corresponding types of MBS session are:
Broadcast session;
Multicast session.

The MBS architecture defined in clause 5 of 3GPP TS 23.247 v17.1.0 follows the 5G System architectural principles as defined in 3GPP TS 23.501, enabling distribution of the MBS data from the 5GS ingress to NG-RAN node(s) and then to the UE. The MBS architecture provides:
Efficient usage of RAN and CN resources, with an emphasis on radio interface efficiency;
Efficient transport for a variety of multicast and broadcast services.

Multicast-broadcast service for roaming is not supported in this release.

Interaction between multicast-broadcast service and support of deployments topologies with specific SMF Service Areas is not specified in this release.

The MBS also provides functionalities such as local MBS service, authorization of multicast MBS and QoS differentiation. Refer to clause 6 of 3GPP TS 23.247 v17.1.0 for more details.

MBS traffic is delivered from a single data source (e.g. Application Service Provider) to multiple UEs. Depending on many factors, there are several delivery methods which may be used to deliver the MBS traffic in the 5GS.

NOTE 1: For clarity, delivery methods are not referred to as unicast/multicast/broadcast but as described below. The term “unicast delivery” refers to a mechanism by which application data and signalling between the UE and the application server are delivered using PDU Session within the 3GPP network and using individual UE and application server addresses (e.g. IP addresses) between the 3GPP network and the application server. It is not equivalent to 5GC Individual MBS traffic delivery method defined in clause 4 of 3GPP TS 23.247 v17.1.0.

Between 5GC and NG-RAN, there are two possible delivery methods to transmit the MBS data:
5GC Individual MBS traffic delivery method: This method is only applied for multicast MBS session. 5GC receives a single copy of MBS data packets and delivers separate copies of those MBS data packets to individual UEs via per-UE PDU sessions, hence for each such UE one PDU session is required to be associated with a multicast session.
5GC Shared MBS traffic delivery method: This method is applied for both broadcast and multicast MBS session. 5GC receives a single copy of MBS data packets and delivers a single copy of those MBS packets to an NG-RAN node, which then delivers the packets to one or multiple UEs.

The 5GC Shared MBS traffic delivery method is required in all MBS deployments. The 5GC Individual MBS traffic delivery method is required to enable mobility when there is an NG-RAN deployment with non-homogeneous support of MBS.

For the multicast session, a single copy of MBS data packets received by the CN may be delivered via 5GC Individual MBS traffic delivery method for some UE(s) and via 5GC Shared MBS traffic delivery method for other UEs.

Between the NG-RAN and the UE, two delivery methods are available for the transmission of MBS data packets over radio interface:
Point-to-Point (PTP) delivery method: NG-RAN delivers separate copies of MBS data packets over radio interface to individual UE(s).
Point-to-Multipoint (PTM) delivery method: NG-RAN delivers a single copy of MBS data packets over radio interface to multiple UEs.

NG-RAN may use a combination of PTP/PTM to deliver MBS data packets to UEs.

NOTE 2: The PTP and PTM delivery methods are defined in RAN WGs.

As depicted in the following figure, 5GC Shared MBS traffic delivery method (with PTP or PTM delivery) and 5GC Individual MBS traffic delivery method may be used at the same time for a multicast MBS session.

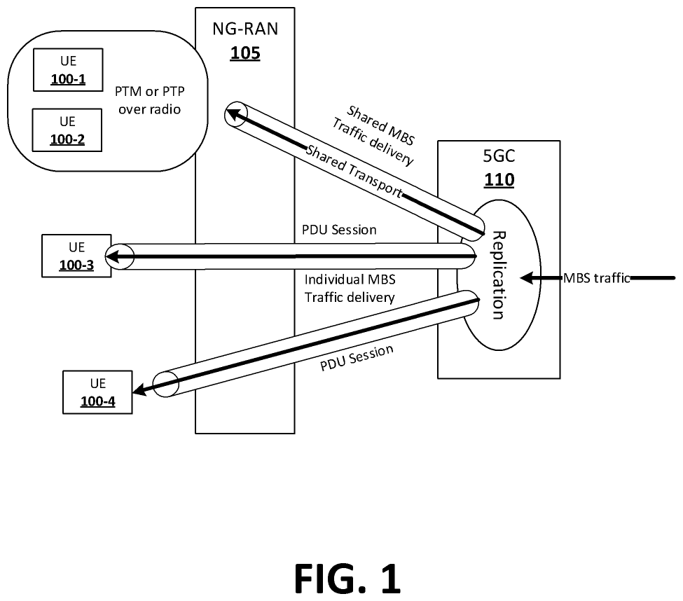

FIG. 1 is a diagram illustrating exemplary delivery methods for an MBS session for which RAN node failure/restart detection and/or restoration according to some embodiments of the present disclosure is applicable. As shown in FIG. 1, multiple UEs 100-1, 100-2, 100-3, and 100-4 may join the MBS session with different delivery methods. For example, the UE 100-1 and the UE 100-2 may be served by the shared MBS traffic delivery via a shared tunnel established between an NG-RAN node 105 and a 5GC 110. In such a case, a single copy of MBS data packets may be delivered from the 5GC 110 to the NG-RAN node 105, which then delivers the packets to the UE 100-1 and UE 100-2 with PTP or PTM delivery methods. For another example, the UE 100-3 and the UE 100-4 may be served by the individual MBS traffic delivery via two separate PDU sessions established between one or more RAN nodes 105 and the 5GC 110. In such a case, separate copies of those MBS data packets may be delivered from the 5GC 110 to individual UEs 100-3 and 100-4 via per-UE PDU sessions.

For MBS broadcast communication, only 5GC Shared MBS traffic delivery method with PTM delivery is applicable.

For MBS multicast communication, if the NG-RAN node supports MBS, the network shall use the 5GC Shared MBS traffic delivery method for MBS data transmission.

NOTE 3: The exception is when the UE moves between NG-RAN node not supporting MBS (with 5GC Individual MBS traffic delivery method) and NG-RAN node supporting MBS, there is temporary co-existence between 5GC Shared MBS traffic delivery method and 5GC Individual MBS traffic delivery method. Refer to clause 6.3 of 3GPP TS 23.247 v17.1.0 for details.

For MBS multicast communication, the switching between 5GC Shared MBS traffic delivery method and 5GC Individual MBS traffic delivery method is supported. The UE mobility between RAN nodes both supporting MBS, and between a RAN node supporting MBS and a RAN node not supporting MBS is supported, for details see clause 6.3 of 3GPP TS 23.247 v17.1.0.

For MBS multicast communication, the switching between PTP and PTM delivery methods for 5GC Shared MBS traffic delivery shall be supported. NG-RAN is the decision point for switching between PTP and PTM delivery methods.

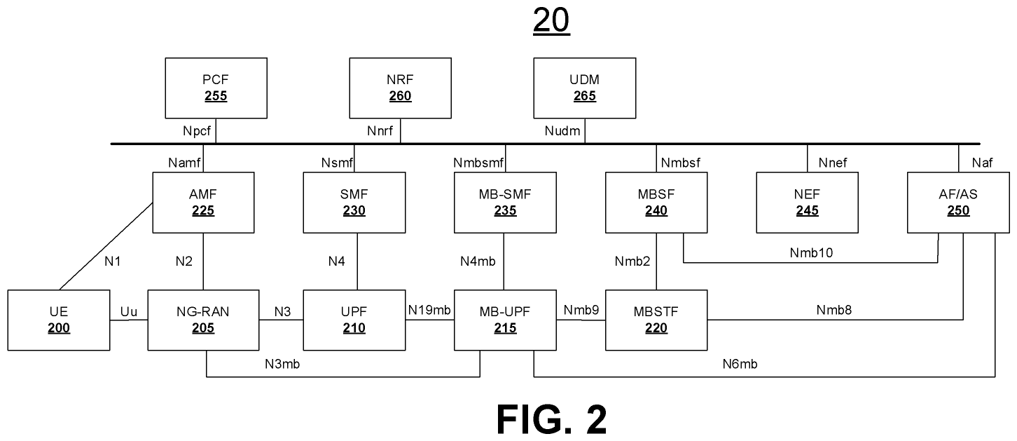

FIG. 2 is a diagram illustrating an exemplary telecommunication network 20 in which RAN node failure/restart detection and/or restoration according to some embodiments of the present disclosure is applicable, and FIG. 2 depicts the MBS reference architecture. Service-based interfaces are used within the Control Plane. Support for interworking at reference points xMB and MB2 is described in Annex C of 3GPP TS 23.247 v17.1.0. Although the telecommunications network 20 is a network defined in the context of 5G NR, the present disclosure is not limited thereto.

As shown in FIG. 2, the network 20 may comprise one or more UEs 200 and an NG-RAN 205, which could be or comprise one or more of base station, a Node B, an evolved NodeB (eNB), a gNB, or an access network (AN) node which provides the UEs 200 with access to other parts of the network 20. Further, the network 20 may comprise its core network portion comprising (but not limited to) an AMF 225, an SMF 230, a User Plane Functions (UPF) 210, a Policy Control Function (PCF) 255, a Network Exposure Function (NEF) 245, an Application Function/Application Server (AF/AS) 250, a Unified Data Management (UDM) 265, and/or a Network Repository Function (NRF) 260. Further, in addition to these network functions, the telecommunication network 20 may further comprise network functions for supporting MBS, comprising (but not limited to) an MB-SMF 235, an MB-UPF 215, a Multicast/Broadcast Service Function (MBSF) 240, and a Multicast/Broadcast Service Transport Function (MBSTF) 220. As shown in FIG. 2, these entities may communicate with each other via the service-based interfaces, such as, Namf, Nsmf, Npcf, etc. and/or the reference points, such as, N1, N2, N3, N4, N4mb, etc.

However, the present disclosure is not limited thereto. In some other embodiments, the network 20 may comprise additional network functions, less network functions, or some variants of the existing network functions shown in FIG. 2. For example, in a network with the 4G architecture, the entities which perform these functions (e.g., mobility management entity (MME)) may be different from those shown in FIG. 2 (e.g., the AMF 225). For another example, in a network with a mixed 4G/5G architecture, some of the entities may be same as those shown in FIG. 2, and others may be different. Further, the functions shown in FIG. 2 are not essential to the embodiments of the present disclosure. In other words, some of them may be missing from some embodiments of the present disclosure. The functions shown in FIG. 2 will be described in detail below.

Referring to FIG. 2, the AMF 225 may provide most of the functions that the MME provides in a 4G network as mentioned above. Below please find a brief list of some of its functions:
Terminates the RAN Control Plane (CP) interface (N2);
Non-access stratum (NAS) signaling;
NAS ciphering and integrity protection;
Mobility Management (MM) layer NAS termination;
Session Management (SM) layer NAS forwarding;
Authenticates UE 200;
Manages the security context;
Registration management;
Connection management;
Reachability management;
Mobility Management; and/or
Apply mobility related policies from PCF 255 (e.g., mobility restrictions).

In addition to the functions defined above, the AMF 225 may further perform at least one of following functions to support MBS:
Signaling with NG-RAN 205 and MB-SMF 235 for MBS Session management;
Selection of NG-RANs 205 for notification of multicast session activation toward UEs 200 in CM-IDLE state;
Selection of NG-RANs 205 for broadcast traffic distribution.

Additionally, the AMF 225 may be aware of NG-RAN 5G MBS capability.

The SMF 230 may provide the session management functions that are handled by the 4G MME, Secure Gateway-Control plane (SGW-C), and PDN Gateway-Control plane (PGW-C). Below please find a brief list of some of its functions:
Allocates IP addresses to UEs;
NAS signaling for session management (SM);
Sends Quality of Service (QOS) and policy information to the NG-RAN 205 via the AMF 225;
Downlink data notification;
Select and control the UPF 210 for traffic routing;
Acts as the interface for all communication related to offered user plane services; and/or
Lawful intercept-control plane.

In addition to the functions defined above, the SMF 230 may further perform at least one of following functions to support MBS:
Discovering MB-SMF 235 for a multicast session;
Authorizing multicast session join operation if needed;
Interacting with MB-SMF 235 to obtain and manage multicast session context; and
Interacting with RAN 205 for shared data transmission resource establishment.

Please note that the SMF 230 and the MB-SMF 235 may be co-located or deployed separately.

Further, the UPFs 210 is essentially a fusion of the data plane parts of the SGW and PGW. In the context of the Control User Plane Separation (CUPS) architecture: Evolved Packet Core (EPC) SGW-U+EPC PGW-U→5G UPF.

The UPFs 210 may perform at least one of following functions:
Packet routing and forwarding
Packet inspection and QoS handling, and the UPF 210 may optionally integrate a Deep Packet Inspection (DPI) for packet inspection and classification;
Connecting to the Internet POP (Point of Presence), and the UPF 210 may optionally integrate the Firewall and Network Address Translation (NAT) functions;
Mobility anchor for Intra RAT and Inter-RAT handovers;
Lawful intercept-user plane; and
Maintains and reports traffic statistics.

In addition to the functions defined above, the UPF 210 may further perform at least one of following functions to support MBS:
Interacting with SMF 230 for receiving multicast data from MB-UPF 215 for 5GC Individual MBS traffic delivery method;
Delivering multicast data to UEs 200 via PDU Session for 5GC Individual MBS traffic delivery method.

Please note that the UPF 210 and MB-UPF 215 may be co-located or deployed separately.

In addition to the functions defined in TS 23.501, the PCF 255 may perform at least one of the following functions to support MBS if dynamic PCC for 5MBS is needed:
Supporting QoS handling for MBS Session;
Providing policy information regarding the MBS Session to MB-SMF 235 for authorizing the related QoS profiles;
Interacting with UDR for QoS information retrieval; and
The PCF 255 can receive MBS information from AF 250, NEF 245 or MBSF 240, e.g. based on the different configuration options.

The MB-SMF 235 may perform at least one of the following functions to support MBS:
General for multicast and broadcast sessions:
   Supporting MBS session management (including QoS control);
   Configuring the MB-UPF 215 for multicast and broadcast flows transport based on the policy rules for multicast and broadcast services from PCF 255 or local policy;
   Allocating and de-allocating Temporary Mobile Group Identity (TMGI);
Specific for broadcast sessions:
   Interacting with RAN 205 (via AMF 225) to control data transport using 5GC Shared MBS traffic delivery method;
Specific for multicast sessions:
   Interacting with SMF 230 to modify PDU Session associated with MBS session;
   Interacting with RAN 205 (via AMF 225 and SMF 230) to establish data transmission resources between MB-UPF 215 and RAN nodes for 5GC Shared MBS traffic delivery method;
   Controlling multicast data transport using 5GC Individual MBS traffic delivery method.

The MB-UPF 215 may perform at least one of the following functions to support MBS:
General for multicast and broadcast sessions:
   Packet filtering of incoming downlink packets for multicast and broadcast flows;
   QoS enforcement (Maximum Flow Bit Rate (MFBR)) and counting/reporting based on existing means;
   Interaction with MB-SMF 235 for receiving multicast and broadcast data;
   Delivery of multicast and broadcast data to RAN nodes 205 for 5GC Shared MBS traffic delivery method;
Specific for multicast sessions:
   Delivery of multicast data to UPF 210 for 5GC Individual MBS traffic delivery method.

In addition to the functions defined in TS 23.501, the NG-RAN 205 may perform at least one of the following functions to support MBS:
Management of MBS QoS flows via N2;
Delivery of MBS data packets from 5GC shared for multiple UEs 200 over radio using PTM or PTP;
Configuration of UE 200 for MBS QoS flow reception at AS layer;
Control switching between PTM and PTP delivery per UE;
Support for multicast sessions continuity during Xn Handover and N2 Handover;
Support notification of multicast session activation over radio toward UEs 200 in CM-IDLE state and CM-CONNECTED with RRC Inactive state.

In addition to the functions defined in TS 23.501, the UE 200 may perform at least one of the following functions to support MBS:
Reception of multicast data using PTM/PTP;
Reception of broadcast data using PTM;
Handling of incoming MBS QoS flows;
Support of signaling for joining and leaving multicast MBS session;
MBS resource management support at AS layer; and
Reception of notification in CM-IDLE state and CM-CONNECTED with RRC Inactive state for multicast data transmission.

The AF 250 may perform at least one of the following functions to support MBS:
Requesting multicast or broadcast service from the 5GC by providing service information including QoS requirement to 5GC;
Instructing MBS session operation towards 5GC if needed; and
Interacting with NEF 245 for MBS related service exposure.

In addition to the functions defined in TS 23.501, the NEF 245 may further perform at least one of the following functions to support MBS:
Providing an interface to AFs 250 for MBS procedures including service provisioning, MBS session and QoS management;
Interacting with AF 250 and NFs in 5GC, e.g., MB-SMF 235 for MBS session operations, determination of transport parameters; and
Selection of MB-SMF 235 to serve an MBS Session.

The MBSF 240 may perform at least one of the following functions to support MBS:
Service level functionality to support MBS, and interworking with LTE MBMS;
Interacting with AF 250 and MB-SMF 235 for MBS session operations, determination of transport parameters, and session transport;
Selection of MB-SMF 235 to serve an MBS Session;
Controlling MBSTF 220 if the MBSTF 220 is used; and
Determination of sender IP multicast address for the MBS session if IP multicast address is sourced by MBSTF 220.

The MBSTF 220 may perform at least one of the following functions to support MBS if deployed:
Media anchor for MBS data traffic if needed;
Sourcing of IP Multicast if needed;
Generic packet transport functionalities available to any IP multicast enabled application such as framing, multiple flows, packet FEC (encoding); and
Multicast/broadcast delivery of input files as objects or object flows.

In addition to the functions defined in TS 23.501, the UDM 265 may further perform at least one of the following functions to support MBS:
Support management of subscription for authorization for multicast MBS sessions.

In addition to the functions defined in TS 23.501, the UDR may perform at least one of the following functions to support MBS if deployed:
Support management of UE authorization information for multicast MBS session; and
Support management of policy information for multicast or broadcast MBS session.

In addition to the functions defined in TS 23.501, the NRF 260 may further perform at least one of the following functions to support 5G MBS:
Support of new NF types MB-SMF and MBSF and their corresponding NF profiles;
For both multicast and broadcast MBS Session, support of MB-SMF discovery based on parameters such as Data Network Name (DNN), Single-Network Slice Selection Assistance Information (S-NSSAI) and MB service area, at MBS Session creation; and
For multicast MBS Session, support of MB-SMF discovery based on MBS Session ID by SMF 230 serving the multicast Session at UE join.

Please note that the MBSF 240 is optional and may be collocated with the NEF 245 or AF/AS 250, and the MBSTF 220 may be an optional network function. Further, the existing service based interfaces of Nnrf, Nudm, and Nsmf may be enhanced to support MBS. The existing service based interfaces of Npcf and Nnef may be enhanced to support MBS. A MBS enabled AF may use either Nmbsf or Nnef to interact with the MBSF.

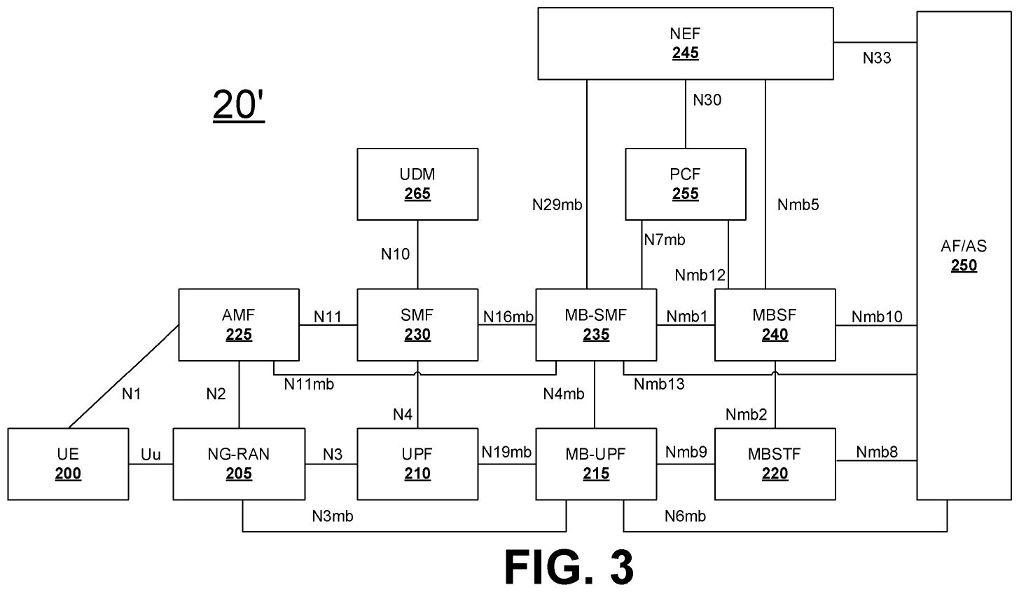

FIG. 3 is a diagram illustrating another exemplary telecommunication network 20′ in which RAN node failure/restart detection and/or restoration according to some embodiments of the present disclosure is applicable, and FIG. 3 depicts the 5G system architecture for MBS using the reference point representation. Since the NFs shown in FIG. 3 are substantially similar to those shown in FIG. 2, and therefore detailed descriptions thereof are omitted for simplicity.

please note that the existing reference points of N1, N2, N4, N10, N11, N30 and N33 may be enhanced to support MBS. Further, regarding the functionalities, Nmb13, N29mb and Nmb1 may be identical, Nmb5 and Nmb10 may be identical, Nmb9 and N6mb may be identical.

Per 3GPP TS 23.247 v17.1.0, unicast or multicast transport over N3mb between NG-RAN and MB-UPF may be applied:
If unicast transport over N3mb is applied, each NG-RAN allocates Tunnel Info (including IP address and TEID) which is provided to MB-UPF (via AMF, MB-SMF) so that the DL MBS packet can be sent to that tunnel entity.
If multicast transport over N3mb is applied, the NG-RAN does not provide Tunnel Info, instead, the NG-RAN joins a multicast IP address provided by the MB-UPF.

The MB-UPF acts as the MBS Session Anchor of an MBS session, and if the MBSTF is involved in the MBS session, then the MBSTF acts as the media anchor of the MBS traffic. The MB-UPF receives only one copy of MBS data packets from AF or MBSTF.

The user plane between MBSTF and MB-UPF, or between MB-UPF and AF, may use either multicast transport or unicast tunnel for the MBS session (depending on application and capabilities of control interface). If the transport network does not support multicast transport, the user plane uses unicast tunnel for the MBS Session. The user plane between MBSTF and AF may use unicast tunnel, multicast transport or other means (e.g., HTTP download from external CDN). If unicast is used for the MBS Session, after receiving the downlink MBS data, the MB-UPF forwards the downlink MBS data without the outer IP header and tunnel header information.

The user plane from the MB-UPF to NG-RAN(s) (for 5GC Shared MBS traffic delivery) and the user plane from the MB-UPF to UPFs (for 5GC Individual MBS traffic delivery) may use multicast transport via a common GTP-U tunnel per MBS session, or use unicast transport via separate GTP-U tunnels at NG-RAN or at UPF per MBS session in the following way
For 5GC Shared MBS traffic delivery (i.e. MB-UPF delivers user plane data to NG-RAN supporting MBS), if the transport network supports IP multicast, the NG-RAN node uses multicast transport via a common GTP-U tunnel per MBS session, otherwise unicast transport via separate GTP-U tunnel per MBS session per NG-RAN node is used.
For 5GC Individual MBS traffic delivery (i.e. MB-UPF delivers user plane data to UPF), if the transport network supports IP multicast and the UPF supports reception of multicast data over N19mb, UPF use multicast transport via a common GTP-U tunnel per MBS session, otherwise unicast transport via separate GTP-U tunnel per MBS session per UPF is used.

If the user plane uses unicast transport, the transport layer destination is the IP address of the NG-RAN or UPF, each NG-RAN or UPF allocates the tunnel separately and multiple GTP-U tunnels are used for the MBS Session. If the user plane uses multicast transport, a common GTP-U tunnel is used for both RAN and UPF nodes. The GTP-U tunnel is identified by a common tunnel ID and an IP multicast address as the transport layer destination, both assigned by 5GC.

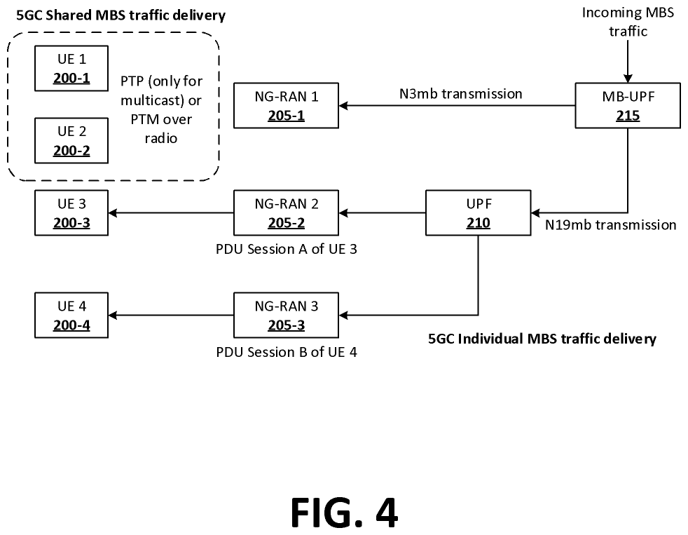

The above is depicted in FIG. 4. There could be more than one NG-RANs or UPFs that are involved in the MBS traffic delivery. FIG. 4 is a diagram illustrating exemplary user plane data transmission in which RAN node failure/restart detection and/or restoration according to some embodiments of the present disclosure is applicable.

Similar to those shown in FIG. 1, multiple UEs 200-1, 200-2, 200-3, and 200-4 may join an MBS session with different delivery methods. For example, the UE #1 200-1 and the UE #2 200-2 may be served by the shared MBS traffic delivery via a shared tunnel, while the UE 200-3 and the UE 200-4 may be served by the individual MBS traffic delivery via two separate PDU sessions A and B.

The MB-SMF instructs the MB-UPF to receive packets related to an MBS session.

For shared delivery (e.g., to UE #1 200-1, UE #2 200-2), if unicast transport over N3mb applies, the MB-SMF instructs MB-UPF (e.g., MB-UPF 215) to replicate the received MBS packets and forward them towards multiple RAN nodes via separate GTP tunnel. For shared delivery, if multicast transport over N3mb applies, the MB-SMF instructs the MB-UPF to replicate the received MBS data and forwards the data via a single GTP tunnel.

For individual delivery (e.g., to UE #3 200-3, UE #4 200-4), the MBS data received by the MB-UPF is replicated towards the UPF(s) (e.g., UPF 210) where individual delivery is performed in the following way:
The MB-SMF configures the MB-UPF to receive packets related to an MBS session, to replicate those packets and forward them towards multiple UPFs via GTP tunnels if unicast transport over N19mb is applied, or via a single GTP tunnel if multicast transport over N19mb is applied.
The SMF(s) instructs the UPF to receive packets related to a multicast session from an MB-UPF over N19mb, to replicate those packets and to forward them in multiple PDU sessions.

For the MB-SMF and MB-UPF, packet detection, replication and forwarding for an MBS session is realized by using for each MBS session one Packet Detection Rule (PDR) that detects the incoming MBS packets and points to one Forwarding Action Rule (FAR) that describes the forwarding of the data towards multiple destinations (UPFs or RAN nodes):
A PFCP session is created when the MBS Session is started, regardless of multicast or unicast transport over N3mb and N19mb.
For Multicast transport over N3mb and N19mb, the destination in the FAR contains the MB-UPF IP Multicast Distribution Info.
For unicast transport over N3mb and N19mb, the FAR in the PFCP session may contain multiple destinations represented by the NG-RAN N3mb Tunnel Info and UPF N19mb Tunnel Info (if applicable).

For the SMF and the UPF (for 5GC individual delivery), packet detection, replication and forwarding for an MBS session is realized by PDR and FAR of the PDU session in which the UE has joined the MBS session:
The SMF instructs the UPF to associate the PFCP session of the PDU session with an MBS session.
A new PDR with Source Interface “Core” is used to detect MBS data from N19mb.

NOTE: This PDR is also containing the MBS session ID to enable a single detection of the incoming MBS data for multiple PDU sessions at the UPF.
For unicast transport over N19mb, the SMF requests UPF to allocate N19mb Tunnel Info if not allocated.
For multicast transport over N19mb, the SMF includes the low layer source specific multicast address information and C-TEID to UPF.
If the SMF wants to maintain the MBS data reception over N19mb but suspends the delivery of the data to the UE's PDU session, the Action of FAR is set to “drop” (e.g. when the UE is switching from 5GC Individual delivery to 5GC Shared delivery due to the UE moving from MBS non-supporting NG-RAN to MBS supporting NG-RAN). Otherwise the SMF removes the related PDR and FAR.

See 3GPP TS 29.244 for the details of user plane handling.

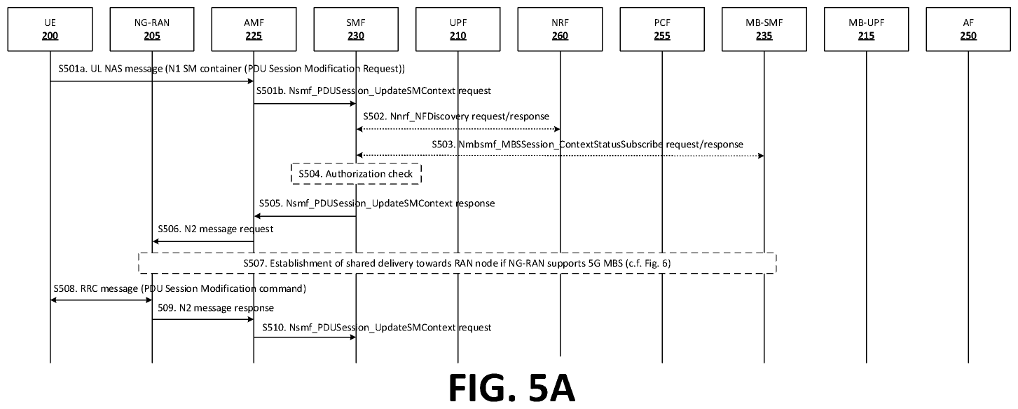

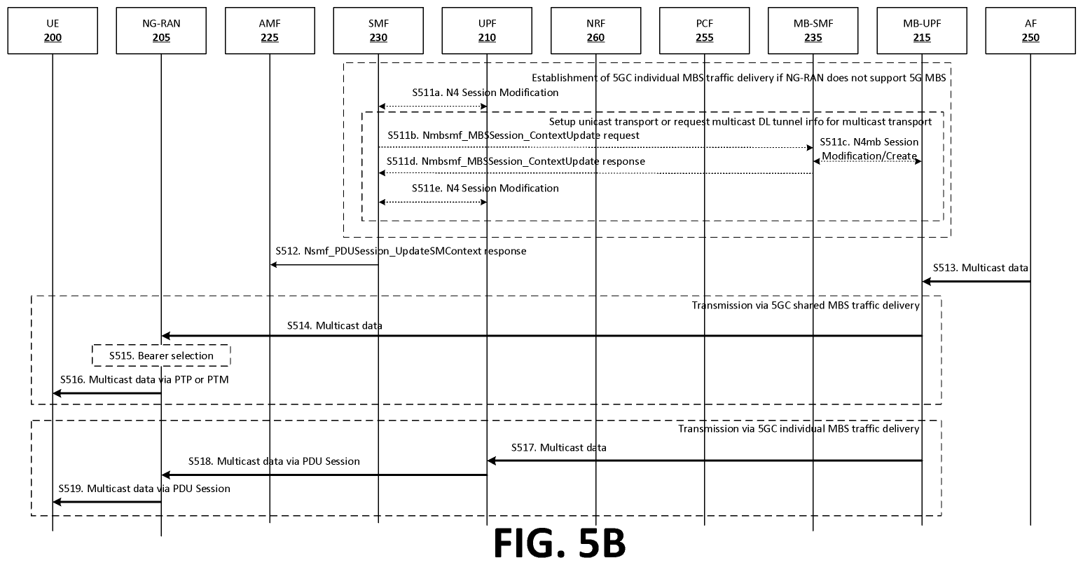

FIG. 5A and FIG. 5B are diagrams illustrating an exemplary procedure for UE joining multicast session, in which RAN node failure/restart detection and/or restoration according to some embodiments of the present disclosure is applicable.

The following steps may be executed before the UE requests to join the MBS session:
The MBS Session may have been created in the 5GC (see clause 7.1.1 of 3GPP TS 23.247 v17.1.0 for details).
The UE registers in the PLMN or SNPN and may have established a PDU session that can be associated with multicast session(s).
The UE has known at least the MBS Session ID of a multicast group that the UE can join, e.g. via service announcement.

As shown in FIG. 5A, at step S501a and S501b, to join the multicast group, the UE sends a PDU Session Modification Request for the associated PDU session which additionally contains one or several MBS Session ID(s) and join request. The MBS Session ID(s) indicate the multicast MBS session(s) that UE wants to join.

The UE may alternatively join the multicast MBS session by sending PDU Session Establishment Request for associated PDU session together with one or several MBS Session ID(s) and join request. In that case, before step S502, the network proceeds with establishment of the associated PDU session executing steps 4 to 10 of PDU Session Establishment procedure as specified in TS 23.502 clause 4.3.2.2.

At an optional step S502, based on the received MBS Session ID and join request, the SMF determines this is MBS Session join request.

If SMF has no information about MBS Session context for the indicated MBS Session ID(s), SMF discovers and selects an MB-SMF for the MBS Session via the NRF as described in clause 7.1.2 of 3GPP TS 23.247 v17.1.0. If no MB-SMF is assigned for the MBS session ID (i.e. the NRF provides empty MB-SMF profile), the SMF may select an MB-SMF and request it to configure the multicast MBS session or the SMF may reject the join request and respond to the UE with an appropriate cause value.

NOTE 1: Details about how the SMF selects an MB-SMF and requests it to configure the multicast MBS session are left to SMF implementation.

At an optional step S503, for each MBS session in step 1, if the SMF has not subscribed to the MBS session context, it invokes

Nmbsmf_MBSSession_ContextStatusSubscribe request (MBS Session ID) towards the MB-SMF to subscribe to events notifications related to the multicast MBS session and to request information about the MBS session context. The MB-SMF responds with the information about the indicated multicast MBS session in

Nmbsmf_MBSSession_ContextStatusSubscribe response (multicast QOS flow information (e.g. QoS profile(s) for multicast MBS session), [start time], [session status indication (active/inactive)], [Any UE indication], [multicast DL tunnel info]).

If it is the first time for the MB-SMF to receive

Nmbsmf_MBSSession_ContextStatusSubscribe request of the indicated MBS Session from any SMF, the MB-SMF learns it is the first UE joining the multicast MBS session. For multicast transport between MB-UPF and content provider, if it is the first UE joining the multicast MBS session, and MB-UPF has not joined the multicast tree in the MBS session creation procedure, described in clause 7.1.1 of 3GPP TS 23.247 v17.1.0, the MB-SMF requests the MB-UPF to join the multicast tree towards the AF/MBSF, otherwise MB-SMF will not send the request to the MB-UPF.

NOTE 2: The MB-SMF can answer the Nmbsmf_MBSSession_ContextStatusSubscribe request either based on information received in the MBS session creation procedures in clause 7.1.1 of 3GPP TS 23.247 v17.1.0 or based on preconfigured information. The pre-configuration also includes information about the MBS session stored in the NRF. If the MB-SMF uses preconfigured information, the pre-configuration also includes MB-UPF configuration.

At step S504, the SMF determines whether the user is authorized to join the multicast session taking into account the MBS subscription data received from the UDM and the Any UE indication if received from the MB-SMF. The SMF considers the UE as authorized to the multicast session if the UE is authorized to use multicast MBS services, and if the MBS Session ID(s) in the PDU Session Modification Request is included in the MBS subscription data or Any UE indication is received. If authorization check fails, the SMF rejects the join request with a cause value. If a UE joins prior to the start time of the multicast MBS session, the SMF may accept the join request and indicate to the UE the start time, or it may reject the join request with an appropriate error cause and optionally a back-off timer. If a UE joins while the multicast MBS session is inactive, the SMF accepts the join request.

At step S505, if the join request is accepted, the SMF responds to the AMF through Nsmf_PDUSession_UpdateSMContext response (N2 SM information (PDU Session ID, MBS Session ID, [updated PDU Session information], [mapping information between unicast QOS flow(s) and multicast QOS flow(s)]), N1 SM container (PDU Session Modification Command)) to:
create an MBS session context for the indicated MBS session in the RAN, if it does not exist in the RAN already; and
inform the NG-RAN about the relation between the multicast MBS Session context and the UE's PDU Session context by including the MBS session ID and the mapping between the multicast QoS flow(s) and associated QoS flow(s).

Based on operator policy, the SMF may prepare for 5GC Individual MBS traffic delivery fall-back. The SMF maps the received QoS information of the multicast Qos Flow into PDU Session's unicast QoS Flow information, and includes the information of the QoS Flows and the mapping information about the QoS Flows in the SM information sent to RAN. The SMF compares the QFIs of the multicast QoS Flows received from the MB-SMF with QFIs in use for the PDU Session and assigns unused QFIs to the PDU Session's unicast QoS Flows corresponding to multicast QoS Flows.

NOTE 3: Detailed information included in N2 SM information will be aligned with by RAN WG3.

NOTE 4: A PDU Session UP activation is not triggered by the N2 SM information if it only includes information related to the multicast MBS session and associated Qos flows and is received by an MBS capable NG RAN node.

NOTE 5: The SMF uses the same QoS in the received MBS QoS Flow Qos information for the associated QoS Flow in the unicast PDU session.

If the MBS session join procedure was triggered by the UE together with PDU Session Establishment procedure for the associated PDU session, the SMF provides the N2 SM information and N1 SM container for the associated PDU session in Namf_Communication_N1N2MessageTransfer service operation towards the AMF, as described in step 11 of clause 4.3.2.2.1 in TS 23.502. The N2 SM information also includes the MBS Session ID and, if 5GC individual MBS traffic delivery fall-back is supported, the mapping information between unicast QoS flow(s) and multicast Qos flow(s).

Editor's note: The implication of not triggering PDU Session UP activation in NG-RAN when SMF informs the NG-RAN of UE join requires RAN collaboration.

If the join request is rejected, the SMF responds to the AMF through Nsmf_PDUSession_UpdateSMContext response (N1 SM container (PDU Session Modification Reject) and the message will not contain any MBS session context or the N2 SM information for the associated PDU session. The PDU Session Modification Reject message is forwarded to the UE via the NG-RAN, and the following steps are skipped.

At step S506, the N2 message, which includes the multicast MBS session information and PDU session modification information is sent to the NG-RAN.

If the MBS is not supported by NG-RAN, 5GC Individual MBS traffic delivery may be used. Otherwise, if the MBS is supported by NG-RAN, 5GC Shared MBS traffic delivery is adopted.

If the NG-RAN supports MBS, the NG-RAN uses the MBS Session ID to determine that the PDU Session identified by the PDU Session ID is associated with the indicated multicast MBS session.

If the NG-RAN supports MBS, the associated unicast QoS flow information is not used to allocate the radio resource and CN resource.

NOTE 6: It is NG-RAN that decides whether radio resource is allocated or not, and it is NG-RAN/UPF that decides whether multicast transport or unicast transport is used between the NG-RAN/UPF and the MB-UPF.

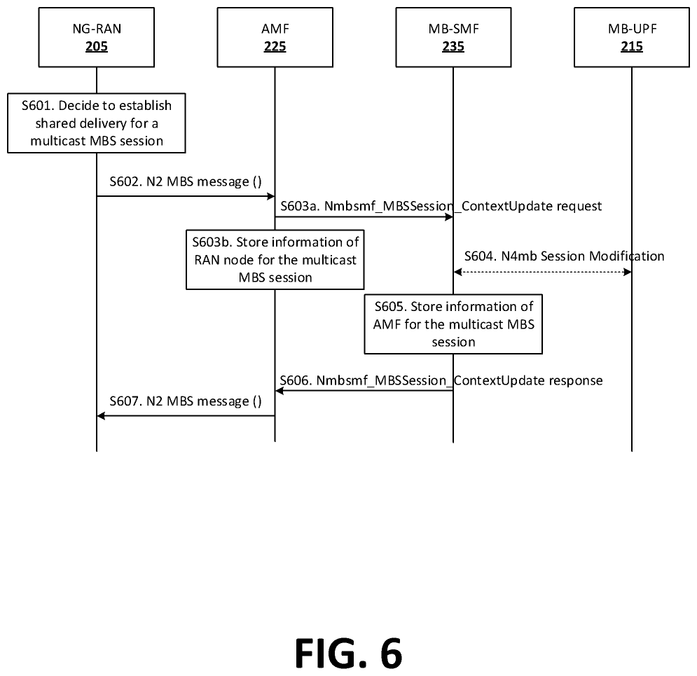

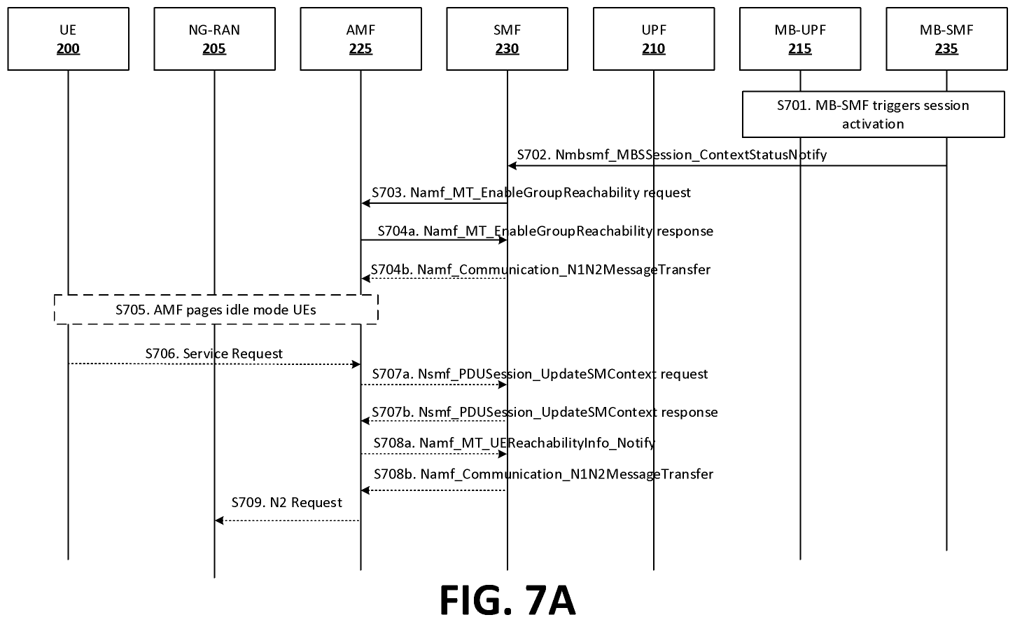

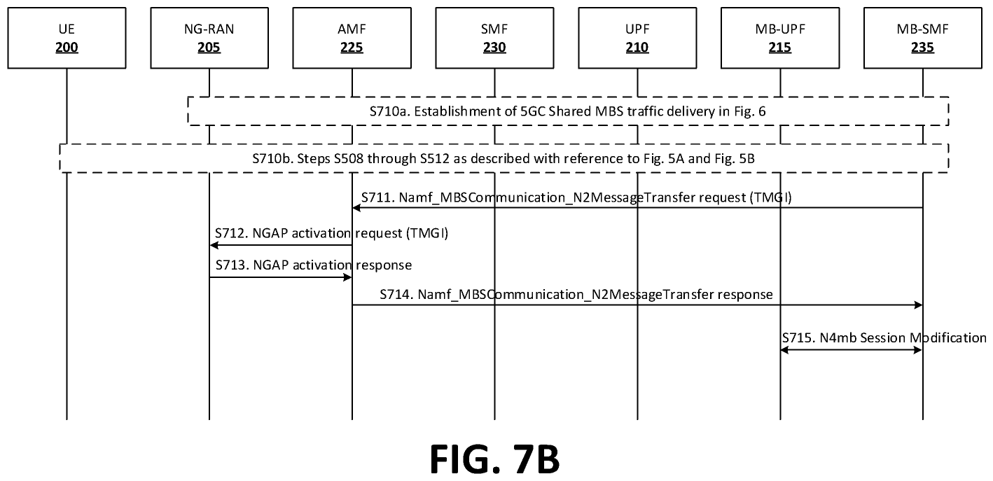

At an optional step S507, if shared tunnel has not been established for the multicast MBS session towards the NG-RAN node, the procedures described with reference to FIG. 6 for the establishment of shared delivery toward NG-RAN node are executed. This step is executed separately for each multicast MBS session.

At step S508, the NG-RAN node performs AN specific signalling exchange with the UE to establish radio resource for the multicast MBS session if not established yet. If the NG-RAN does not support MBS, radio resource are reconfigured for unicast transmission of the MBS data over the associated PDU session. As part of the AN specific signalling exchange, the N1 SM container (PDU Session Modification Command) is provided to the UE.

At step S509, the NG-RAN node sends the PDU session modification response. If the MBS is not supported by NG-RAN, the accepted unicast QoS flow is included in the N2 SM response container. If the MBS is supported by NG-RAN, the N2 SM response container further includes the indication of supporting MBS.

At step S510, the AMF invokes Nsmf_PDUSession_UpdateSMContext request ([N2 SM container]) to the SMF.

Per the indication of whether the NG-RAN supports MBS, the SMF determines the delivery mode, i.e. whether 5GC Individual MBS traffic delivery is used for multicast data transmission.

NOTE 7: If the shared tunnel is used, no interaction with UPF is needed for the indicated multicast MBS session

As shown in FIG. 5B, the step S511a through S511e are optional and used for 5GC Individual MBS traffic delivery, if the related NG-RAN does not support MBS. If a shared tunnel between the UPF (PSA) and MB-UPF for 5GC Individual MBS traffic delivery has not yet been established by the SMF for the multicast MBS session, steps S511a to S511d are executed. Step S511e is executed irrespective of that.

At step S511a, the SMF contacts the UPF to request the creation of a tunnel and provides the MBS session ID. The UPF indicates to the SMF whether the tunnel for this multicast MBS session is newly allocated (as there can be multiple SMFs interacting with the same UPF for the same multicast MBS Session).

If the UPF determines to use unicast transport over N19mb, the UPF allocates a DL N19mb Tunnel endpoint for the multicast MBS session if the SMF request is the first one to allocate DL N19mb Tunnel endpoint for the multicast MBS Session in the UPF. The UPF includes the DL Tunnel Info in the response to the SMF. The DL tunnel info includes the downlink tunnel ID and the UPF address.

If the UPF determines to use multicast transport over N19mb, the UPF joins the multicast distribution if the SMF request is the first one for the MBS Session in the UPF. Steps S511b to S511d are skipped.

At step S511b, if the UPF indicates the DL N19mb Tunnel is newly allocated, the SMF invokes Nmbsmf_MBSsession_ContextUpdate request (MBS Session ID, [DL tunnel info]) towards the MB-SMF for establishing the multicast MBS session transport between MB-UPF and UPF.

At step S511c, if the DL tunnel info of the UPF is received, the MB-SMF configures the MB-UPF to transmit the multicast MBS session data towards UPF using the possibly received downlink tunnel ID.

At step S511d, the MB-SMF responds to the SMF through

Nmbsmf_MBSSession_ContextUpdate response (MBS Session ID, [multicast DL tunnel info]). If the UPF DL tunnel info for unicast transport is not received by the MB-SMF, multicast transport between MB-UPF and UPF is to be used, and the MB-SMF includes the downlink tunnel information with the low layer transport multicast address for the multicast MBS session.

At step S511e, the MB-SMF configures the MB-UPF to forward the received multicast MBS session data within the PDU session. (This step may be combined with step S511a).

At step S512, the SMF responds to the AMF with Nsmf_PDUSession_UpdateSMContext response message.

At step S513, the MB-UPF receives multicast PDUs, either directly from the content provider or via the MBSTF that can manipulate the data.

Steps S514 to S516 are for 5GC Shared MBS traffic delivery:

At step S514, the MB-UPF sends multicast PDUs in the N3mb tunnel associated to the multicast MBS session to the NG-RAN. There is only one tunnel per multicast MBS session and NG-RAN node, i.e., all the UEs which have joined the multicast MBS session via the NG-RAN node share this tunnel for reception of the multicast MBS session data.

At step S515, the NG-RAN selects PTM or PTP radio bearers to deliver the multicast PDUs to the UE(s) that have joined the multicast MBS session.

At step S516, the NG-RAN transmits the multicast MBS session data to the UE(s) using the selected PTM or PTP radio bearer(s).

Steps S517 to S519 are for 5GC Individual MBS traffic delivery:

At step S517, the MB-UPF sends multicast PDUs in the N19mb tunnel associated to the multicast MBS session to the UPF. There is only one tunnel per multicast MBS session and destination UPF, i.e., all associated PDU sessions served by the destination UPF share this tunnel.

At step S518, the UPF forwards the multicast data towards the NG-RAN via unicast (i.e. in the N3 tunnel of the associated PDU Session).

At step S519, the NG-RAN forwards the multicast MBS session data to the UE via unicast (i.e. over the radio bearer(s) corresponding to the associated QoS flow(s) of the associated PDU Session).

NOTE 8: Details of the DL MBS data transmission are described in clause 6.7 of 3GPP TS 23.247 v17.1.0.

NOTE 9: When the MBSF is involved in the multicast MBS session, the tunnel between MBSTF and MB-UPF has been established in the MBS session creation procedure.

FIG. 6 is a diagram illustrating an exemplary procedure for establishing share delivery toward NG-RAN node, in which RAN node failure/restart detection and/or restoration according to some embodiments of the present disclosure is applicable.

In the following cases, a shared tunnel for shared delivery is established between the NG-RAN and MB-UPF:
The first UE is included in the context of the MBS session in the NG-RAN.

NOTE 1: When the multicast MBS session is deactivated, if there is at least one UE joining the multicast MBS session is in RRC-CONNECTED state in the NG-RAN, the shared delivery is not released.

NOTE 2: Share delivery establishment procedures are used when MBS supporting NG-RAN node(s) get involved in the multicast MBS session regardless of the state of the multicast MBS session.
Handover to the target NG-RAN when the shared delivery tunnel is not established in the target RAN node for this multicast MBS session.

As shown in FIG. 6, at step S601, an NG-RAN node decides to establish shared delivery for a multicast MBS session when it serves at least one UE within the multicast MBS session. For location dependent services, the NG-RAN node needs to establish shared delivery for the location dependent contents of a multicast MBS session if it serves at least one UE assigned to an MBS session ID and area session ID.

At step S602, the NG-RAN sends an N2 MBS Session request message (MBS Session ID, [Area Session ID], N2 SM information ([unicast DL tunnel Info]) towards the AMF.

If the NG-RAN node is configured to use unicast transport for the shared delivery, it allocates a GTP tunnel endpoint and provides the unicast DL tunnel Info in the request, which includes the GTP tunnel endpoint and NG-RAN node address. For location dependent MBS services, the NG-RAN node also provides the Area Session ID.

At step S603, the AMF selects the MB-SMF serving the multicast MBS session, e.g. using the NRF discovery service or locally stored information. It invokes Nmbsmf_MBSSession_ContextUpdate request (MBS Session ID, [Area Session ID], N2 SM information) to the MB-SMF at step S603a.

The AMF stores the information of the NG-RAN nodes (e.g. NG-RAN node ID) for the subsequent signaling related to the multicast MBS Session at S603b.

At an optional step S604, if the MB-SMF received unicast DL tunnel Info in step S603, it configures the MB-UPF to send multicast data for the multicast MBS session (or location dependent content of the multicast MBS session if an area session ID was received) towards that GTP tunnel endpoint via unicast transport.

At step S605, the MB-SMF stores the information of the AMF (e.g. AMF ID) in the MBS multicast session context (or location dependent part of the multicast MBS session context if an Area Session ID was received) to enable subsequent signalling towards that AMF.

At step S606, the MB-SMF sends Nmbsmf_MBSSession_ContextUpdate response (MBS Session ID, [Area Session ID], N2 SM information ([TMGI], multicast QoS flow information, [multicast DL tunnel Info], [MBS service area]) to the AMF. If the MB-SMF did not receive unicast DL tunnel Info in step S603, it provides the multicast DL tunnel info that includes transport multicast address (e.g. a LL SSM) and a GTP tunnel endpoint for multicast transport of the shared delivery.

At step S607, the AMF sends an N2 MBS Session response message (MBS Session ID, [Area Session ID], N2 SM information) to the NG-RAN node. If the NG-RAN node receives the multicast DL tunnel Info of the shared delivery, it uses the transport multicast address included in the multicast DL tunnel info to join the multicast transport distribution.

FIG. 7A and FIG. 7B are diagrams illustrating an exemplary MBS session activation procedure in which RAN node failure/restart detection and/or restoration according to some embodiments of the present disclosure is applicable.

The following can trigger the MBS session activation procedure:
AF requests MB-SMF to activate the MBS session;
MB-UPF receives the multicast data and notifies MB-SMF.

In this procedure, steps S702 to S710 and steps S711 to S714 can be executed in parallel.

As shown in FIG. 7A, at step S701, the procedure may be triggered by the following events:
When the MB-UPF receives downlink data for a multicast MBS session, based on the instruction from the MB-SMF (as described in clause 7.2.5.3 of 3GPP TS 23.247, v17.1.0), the MB-UPF sends N4mb Notification (N4 Session ID) to the MB-SMF for indicating the arrival of DL MBS data.
The AF sends MBS Activation request (TMGI) to the MB-SMF directly or via NEF. At step S702, MB-SMF sends Nmbsmf_MBSSession_ContextStatusNotify (MBS Session ID, multicast session activated) to SMF(s).

The SMF sets the related multicast MBS session state as “Active” state and finds out the list of UEs that joined the multicast MBS session identified by the related TMGI. If the SMF determines the user plane of the associated PDU session(s) of the UE(s) with respect to the TMGI are activated already, steps S703 to S708a will be skipped for those UE(s).

At step S703, the SMF invokes Namf_MT_EnableGroupReachability Request (List of UEs, [PDU Session ID of the associated PDU Sessions], TMGI, [UE reachability Notification Address]) to AMF(s). When later UE is reachable, the UE reachability Notification Address is used by the AMF to identify and notify the related SMF.

After receiving the request, for each UE in the list, the AMF determines CM state of the UE: see steps S704 to S707.

At step S704a, if there are UEs involved in the multicast MBS Session and in CM-CONNECTED state, the AMF indicates those UEs to the SMF, using Namf_MT_EnableGroupReachability Response (UE list). Otherwise, the response does not include UE list.

At step S704b, for each UE in the UE list included in step S704a, if the Qos profile(s) for associated QoS flow(s) has not yet been provided for the PDU session, the SMF invokes Namf_Communication_N1N2MessageTransfer (N2 SM information (PDU Session ID, MBS Session ID, [QOS profile(s) for associated QOS flow(s)], [mapping information between the unicast QOS flow and multicast QOS flow])) to the AMF for the UE which is identified in step S704a. The associated QoS profiles as well as the mapping information between the unicast QoS flow and multicast QoS flow are included to support the 5GC Individual MBS traffic delivery.

The procedure continues at step S709.

At an optional step S705, if AMF determines that there are UEs in CM-IDLE state and involved in the multicast MBS Session, the AMF figures out the paging area covering all the registration areas of those UE(s), which need to be paged. The AMF sends a paging request message to the NG-RAN node(s) belonging to this Paging Area with the TMGI as the identifier to be paged if the related NG-RAN node(s) support MBS. If the NG-RAN node(s) does not support MBS, the AMF sends Paging message to the NG-RAN node(s) per UE without using the MBS Session ID as described in step 4b in clause 4.2.3.3 of TS 23.502.

NOTE 1: The details of the paging are specified by the RAN WGs.

At step S706, the UE(s) in CM-IDLE state sends Service Request message to the AMF, see clause 4.2.3 of TS 23.502.

At step S707a/S707b, after receiving the Service Request sent by the UE(s),
Either based on the received PDU Session ID in step S703, the AMF identifies the related SMF and invokes Nsmf_PDUSession_UpdateSMContext request. The procedure continues at step S709; or
Based on the received UE reachability Notification Address in step S703, the AMF identifies and notifies the related SMF of the UE(s), which are reachable now and its Location Information, by using the Namf_MT_UEReachabilityInfoNotify message. In this case, it can be a separated notification or combined with step S708.

At step S708a, for UE(s) that do not respond to paging, the AMF informs the SMF of the paging failure in Namf_MT_UEReachabilityInfoNotify.

At step S708b, for UE(s) that is indicated as reachable via the Namf_MT_UEReachabilityInfoNotify message, or user plane of the associated PDU session is activated already but the QoS profile(s) for associated QoS flow(s) needs to be provided for the PDU session, the SMF invokes Namf_Communication_N1N2MessageTransfer (N2 SM information ( ) to the AMF same as described in step S704b.

At step S709, the AMF sends N2 request message (N2 SM information ( ) to the RAN node.

As shown in FIG. 7B, at step S710a, if the shared tunnel has not been established before, the shared tunnel is established at this step, as described with reference to FIG. 6. The NG-RAN configures UE with RRC messages if needed.

At step S710b, steps S508 to S512 described with reference to FIG. 5A and FIG. 5B are performed. If 5GC Individual MBS traffic delivery is used, the SMF configures the UPF for individual delivery and if necessary requests the MB-SMF to configure the MB-UPF to send multicast data to the UPF.

At step S711, if the MB-SMF finds out there are shared tunnel established, step S711 to S715 are performed. The MB-SMF invokes

Namf_MBSCommunication_N2MessageTransfer Request (TMGI, N2 SM Information (Activation, TMGI)) to the AMF for those NG-RAN nodes, which have shared tunnel with MB-UPF. This step may be performed in parallel with step S702.

NOTE 2: The messages in steps S710a, S711 and S712 are MBS-specific and it is possible that the AMF(s) in steps S710a, S711 and S712 are not associated to any UEs involved in the multicast MBS Session.

At step S712, the AMF sends NGAP activation request message (N2 SM Information ( ) to the NG-RAN nodes. For those UEs that have joined in the MBS Session and are in RRC-INACTIVE state, the RAN nodes perform RAN paging as specified in 3GPP TS 38.300.

At step S713, the NG-RAN nodes responses to AMF by NGAP activation response message. The NG-RAN nodes establish radio resources to transmit multicast MBS session data to the UE(s). The NG-RAN shall not release the radio connection of a UE that has joined into the multicast session only because no unicast traffic is received for the UE.

At step S714, AMF to MB-SMF: Namf_MBSCommunication_N2MessageTransfer Response ( )

At step S715, the MB-SMF sends N4mb Session Modification Request to the MB-UPF to forward the receiving packet. The MB-UPF responds to the MB-SMF with N4mb Session Modification Response acknowledging the MB-SMF request. See clause 4.4 of TS 23.502 for more details.

3GPP TS 23.527 v17.1.0 specifies the restoration procedures in the 5G system. When it comes to NG-RAN failure and restart, it contains:
1. Upon a NG-RAN restart, where it will lose all session contexts, and then upon receiving DL packets from the UPF towards an unknown GTP-U Tunnel Endpoint, it will send a GTP-U error indication. The UPF will then report the receiving GTP-U error indication to the SMF; so that the SMF can decide if to restore the session in the restarted NF-RAN; (clause 5.2.1 of TS 23.527).
2. Upon a NG-RAN (partial) failure without restart or there is a user plane path between a NG-RAN and a UPF, the UP function can detect such failure using GTP-U Echo Request/Response mechanism, i.e., if the UPF doesn't receive the corresponding GTP-U Echo Response for an operator's configurable retry times, then the UPF will determine the failure of GTP-U path and report the failure to the SMF (clause 5.2.2 of TS 23.527).

Some content below specifies the procedures supported in the 5G System to detect and handle failures affecting the user plane interfaces N3 and N9

A GTP-U entity may lose its GTP-U contexts upon a failure or restart.

When a GTP-U node receives a G-PDU for which no corresponding GTP-U tunnel exists, the GTP-U node shall discard the G-PDU and return a GTP-U Error Indication to the sending node, as specified in clause 7.3.1 of 3GPP TS 29.281.

The receipt of a GTP-U Error Indication is an indication for the sending GTP-U entity that the peer GTP-U entity cannot receive any more user plane traffic on the corresponding GTP-U tunnel.

A GTP-U entity may detect a user plane path failure by using GTP-U Echo Request and Echo Response messages, as specified in clause 20.3.1 of 3GPP TS 23.007.

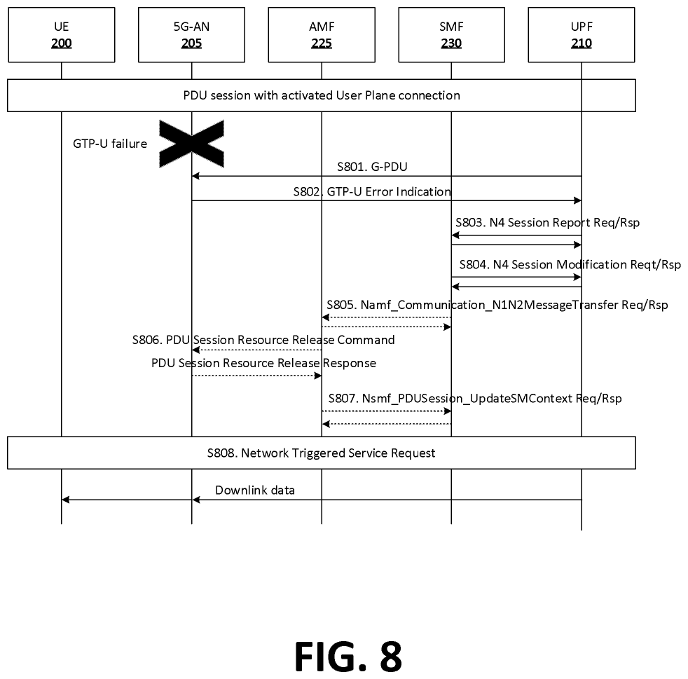

FIG. 8 is a diagram illustrating an exemplary procedure for GTP-U error indication from 5G-AN, in which RAN node failure/restart detection and/or restoration according to some embodiments of the present disclosure is applicable.

The following content specifies the behavior of the different network entities when receiving a GTP-U Error Indication.

As shown in FIG. 8, the user plane connection of an existing PDU session is activated. Downlink G-PDUs are sent towards the 5G-AN at step S801.

At step S802, the 5G-AN returns a GTP-U Error Indication if it does not have a corresponding GTP-U context (see clause 5.2 of 3GPP TS 23.527 v17.1.0).

At step S803, upon receipt of a GTP-U Error Indication, the UPF shall identify the related PFCP session and send an Error Indication Report to the SMF, as specified in clause 5.10 of 3GPP TS 29.244.

At step S804, for a GTP-U Error Indication received from a 5G-AN, the SMF shall modify the PFCP session to instruct the UPF to buffer downlink packets.

At step S805, if the user plane connection of the PDU session is seen as activated by the SMF, the SMF shall initiate an Namf_Communication_N1N2Message Transfer service operation to request the 5G-AN to release the PDU session's resources, as specified in clause 4.3.7 of 3GPP TS 23.502.

At step S806, upon receipt of an Namf_Communication_N1N2MessageTransfer request to transfer the PDU Session Resource Release Command, the AMF shall:
proceed with the request, as specified in clause 5.2.2.3.1 of 3GPP TS 29.518, if the UE is in CM-CONNECTED state for the Access Network Type associated to the PDU session;
otherwise, reject the request with an error indicating that the UE is in CM-IDLE state for the Access Network Type associated to the PDU session.

At step S807, if the AMF sent a PDU Session Resource Release Command to the 5G-AN, the PDU session's resource release is acknowledged to the SMF.

At step S808, the SMF initiates the Network Triggered Service Request procedure specified in clause 4.2.3.3 of 3GPP TS 23.502, to re-activate the user plane connection of the PDU session.

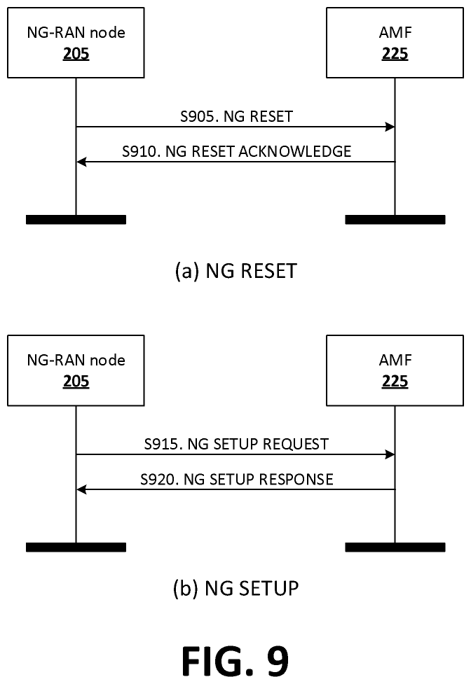

FIG. 9 is a diagram illustrating an exemplary NG RESET procedure and an exemplary NG SETUP procedure in which RAN node failure/restart detection and/or restoration according to some embodiments of the present disclosure is applicable.

As shown in (a) of FIG. 9, an NG reset initiated by the NG-RAN node is provided.

In the event of a failure at the NG-RAN node which has resulted in the loss of some or all transaction reference information, an NG RESET message shall be sent to the AMF at step S905.

At reception of the NG RESET message the AMF shall release all allocated resources on NG related to the UE association(s) indicated explicitly or implicitly in the NG RESET message and remove the NGAP ID for the indicated UE associations.

After the AMF has released all assigned NG resources and the UE NGAP IDs for all indicated UE associations which can be used for new UE-associated logical NG-connections over the NG interface, the AMF shall respond with the NG RESET ACKNOWLEDGE message at step S910.

If the NG RESET message contains the UE-associated Logical NG-connection List IE, then:
The AMF shall use the AMF UE NGAP ID IE and/or the RAN UE NGAP ID IE to explicitly identify the UE association(s) to be reset.
The AMF shall include in the NG RESET ACKNOWLEDGE message, for each UE association to be reset, the UE-associated Logical NG-connection Item IE in the UE-associated Logical NG-connection List IE. The UE-associated Logical NG-connection Item IEs shall be in the same order as received in the NG RESET message and shall include also unknown UE-associated logical NG-connections. Empty UE-associated Logical NG-connection Item IEs, received in the NG RESET message, may be omitted in the NG RESET ACKNOWLEDGE message.
If the AMF UE NGAP ID IE is included in the UE-associated Logical NG-connection Item IE for a UE association, the AMF shall include the AMF UE NGAP ID IE in the corresponding UE-associated Logical NG-connection Item IE in the NG RESET ACKNOWLEDGE message.
If the RAN UE NGAP ID IE is included in a UE-associated Logical NG-connection Item IE for a UE association, the AMF shall include the RAN UE NGAP ID IE in the corresponding UE-associated Logical NG-connection Item IE in the NG RESET ACKNOWLEDGE message.
   Interactions with Other Procedures:

If the NG RESET message is received, any other ongoing procedure (except for another NG Reset procedure) on the same NG interface related to a UE association, indicated explicitly or implicitly in the NG RESET message, shall be aborted.

As shown in (b) of FIG. 9, an NG SETUP initiated by the NG-RAN node is provided.

The purpose of the NG Setup procedure is to exchange application level data needed for the NG-RAN node and the AMF to correctly interoperate on the NG-C interface. This procedure shall be the first NGAP procedure triggered after the TNL association has become operational. The procedure uses non-UE associated signalling.

This procedure erases any existing application level configuration data in the two nodes, replaces it by the one received and clears AMF overload state information at the NG-RAN node. If the NG-RAN node and AMF do not agree on retaining the UE contexts this procedure also re-initialises the NGAP UE-related contexts (if any) and erases all related signalling connections in the two nodes like an NG Reset procedure would do.

At step S915, the NG-RAN node initiates the procedure by sending an NG SETUP REQUEST message including the appropriate data to the AMF. The AMF responds with an NG SETUP RESPONSE message including the appropriate data at step S920.

If the Configured TAC Indication IE set to “true” is included for a Tracking Area contained in the Supported TA List IE in the NG SETUP REQUEST message, the AMF may take it into account to optimise NG-C signalling towards this NG-RAN node.

If the UE Retention Information IE set to “ues-retained” is included in the NG SETUP REQUEST message, the AMF may accept the proposal to retain the existing UE related contexts and signalling connections by including the UE Retention Information IE set to “ues-retained” in the NG SETUP RESPONSE message.

If the AMF supports IAB, the AMF shall include the IAB Supported IE in the NG SETUP RESPONSE message.

The AMF shall include the Backup AMF Name IE, if available, in the Served GUAMI List IE in the NG SETUP RESPONSE message. The NG-RAN node shall, if supported, consider the AMF as indicated by the Backup AMF Name IE when performing AMF reselection, as specified in TS 23.501.

If the GUAMI Type IE is included in the NG SETUP RESPONSE message, the NG-RAN node shall store the received value and use it for further AMF selection as defined in TS 23.501.

If the RAN Node Name IE is included in the NG SETUP REQUEST message, the AMF may use this IE as a human readable name of the NG-RAN node. If the Extended RAN Node Name IE is included in the NG SETUP REQUEST message, the AMF may use this IE as a human readable name of the NG-RAN node and shall ignore the RAN Node Name IE if also included.

If the AMF Name IE is included in the NG SETUP RESPONSE message, the NG-RAN node may use this IE as a human readable name of the AMF. If the Extended AMF Name IE is included in the NG SETUP RESPONSE message, the NG-RAN node may use this IE as a human readable name of the AMF and shall ignore the AMF Name IE if also included.

If the NB-IoT Default Paging DRX IE is included in the NG SETUP REQUEST message, the AMF shall take it into account for paging.

If the RAT Information IE is included in the NG SETUP REQUEST message, the AMF shall handle this information as specified in TS 23.502.

If the NID IE within the NPN Support IE is included within a Broadcast PLMN Item IE in the NG SETUP REQUEST message, the AMF shall consider that the NG-RAN node supports the indicated S-NSSAI(s) for the corresponding tracking area code for the SNPN identified by the PLMN Identity IE and the NID IE.

If the NID IE within the NPN Support IE is included within a PLMN Support Item IE in the NG SETUP RESPONSE message, the NG-RAN node shall consider that the AMF supports the SNPN identified by the PLMN Identity IE and the NID IE.

RFC 4960 specifies the following for SCTP path failure:

When its peer endpoint is multi-homed, an endpoint should keep an error counter for each of the destination transport addresses of the peer endpoint.

Each time the T3-rtx timer expires on any address, or when a HEARTBEAT sent to an idle address is not acknowledged within an RTO, the error counter of that destination address will be incremented.

When the value in the error counter exceeds the protocol parameter ‘Path. Max.Retrans’ of that destination address, the endpoint should mark the destination transport address as inactive, and a notification SHOULD be sent to the upper layer.

When an outstanding TSN is acknowledged or a HEARTBEAT sent to that address is acknowledged with a HEARTBEAT ACK, the endpoint shall clear the error counter of the destination transport address to which the DATA chunk was last sent (or HEARTBEAT was sent). When the peer endpoint is multi-homed and the last chunk sent to it was a retransmission to an alternate address, there exists an ambiguity as to whether or not the acknowledgement should be credited to the address of the last chunk sent. However, this ambiguity does not seem to bear any significant consequence to SCTP behavior. If this ambiguity is undesirable, the transmitter may choose not to clear the error counter if the last chunk sent was a retransmission.

Note: When configuring the SCTP endpoint, the user should avoid having the value of ‘Association. Max.Retrans’ larger than the summation of the ‘Path.Max.Retrans’ of all the destination addresses for the remote endpoint. Otherwise, all the destination addresses may become inactive while the endpoint still considers the peer endpoint reachable. When this condition occurs, how SCTP chooses to function is implementation specific.

When the primary path is marked inactive (due to excessive retransmissions, for instance), the sender MAY automatically transmit new packets to an alternate destination address if one exists and is active. If more than one alternate address is active when the primary path is marked inactive, only ONE transport address SHOULD be chosen and used as the new destination transport address.

AMF events, the following are cited from TS 29.518 for AMF supported event: The AMF may offer this service as a Service Producer to enable an NF to subscribe to event notifications on its own or on behalf of another NF and get notified about an event. The known Service Consumers are NEF, SMF, UDM, NWDAF, DCCF, LMF and GMLC. See also clause 5.34.7 of 3GPP TS 23.501 and clauses 4.15.1, 4.15.3.2, 4.15.4.2 and 5.2.2.3.1 of 3GPP TS 23.502, clause 6.2.2 in 3GPP TS 23.288.

The following events are provided by Namf_EventExposure Service:

### Event: Location-Report

A NF subscribes to this event to receive the Last Known Location or the Current Location of a UE or a group of UEs or any UE, and Updated Location of any of these UEs when AMF becomes aware of a location change of any of these UEs with the granularity as requested.
This event implements the “Location Reporting” event in table 4.15.3.1-1 of 3GPP TS 23.502.
UE Type: One UE, Group of UEs, any UE
Report Type: One-Time Report, Continuous Report (See NOTE 1), Periodic Report (See NOTE 1 and 2)
Input: UE-ID(s), “ANY_UE”, optional filters: TAI, Cell-ID, N3IWF, UE-IP, UDP-PORT, TNAP ID, TWAP ID, Global Line Id
Notification: UE-ID, filtered updated location (TAI, Cell-ID for 3GPP access, most recent N3IWF node, UE local IP address and UDP source port number for non-3GPP access, TNAP ID, TWAP ID, Global Line Id).

NOTE 1: Support of Continuous Report or Periodic Report should be controlled by operator policy.

NOTE 2: For Periodic Report, UE Last Known Location is reported if the UE is in CM-IDLE state when the report is being generated.

### Event: Presence-In-AOI-Report

A NF subscribe to this event to receive the current present state of a UE or a group of UEs or any UE in a specific Area of Interest (AOI), and notification when a specified UE enters or leaves the specified area. The area could be identified by a TA list, an area ID or specific interested area name like “LADN”.
UE Type: One UE, Group of UEs, any UE
Report Type: One-Time Report, Continuously Report
Input: UE ID(s), “ANY_UE”, Area identifier (a TA list, an area Id or “LADN”), S-NSSAI, NSI ID.
Notification: UE-ID(s), Area identifier, Presence Status (IN/OUT/UNKNOWN)

### Event: Time-Zone-Report

A NF subscribes to this event to receive the current time zone of a UE or a group of UEs, and updated time zone of the UE or any UE in the group when AMF becomes aware of a time zone change of the UE.
UE Type: One UE, Group of UEs
Report Type: One-Time Report, Continuous Report
Input: UE ID(s)
Notification: UE-ID, most recent time-zone

### Event: Access-Type-Report

A NF subscribes to this event to receive the current access type(s) of a UE or a group of UEs or any UE, and updated access type(s) of any of the UEs when AMF becomes aware of the access type change of any of these UEs. The area could be identified by a TA list, an area ID or specific interested area name like “LADN”.
UE Type: One UE, Group of UEs, any UE
Report Type: One-Time Report, Continuous Report
Input: UE ID(s), “ANY_UE”, optionally filters: Area identifier (a TA list, an area Id or “LADN”)
Notification: UE ID, most recent access-types (3GPP, Non-3GPP)

### Event: Registration-State-Report

A NF subscribes to this event to receive the current registration state of a UE or a group of UEs or any UE, and report for updated registration state of any of these UEs when AMF becomes aware of a registration state change of any of these UEs.

The area could be identified by a TA list, an area ID or specific interested area name like “LADN”.
UE Type: One UE, Group of UEs, any UE
Report Type: One-Time Report, Continuous Report
Input: UE ID(s), “ANY_UE”, optionally filters: Area identifier (a TA list, an area Id or “LADN”)
Notification: UE ID, most recent registration state (REGISTERED/DEREGISTERED) with access type

### Event: Connectivity-State-Report

A NF subscribes to this event to receive the current connection management state of a UE or a group of UEs, and report for updated connection management state of a UE or any UE in the group when AMF becomes aware of a connection management state change of the UE.
UE Type: One UE, Group of UEs
Report Type: One-Time Report, Continuous Report
Input: UE ID(s)
Notification: UE ID, most recent connection management state (IDLE/CONNECTED) with access type

### Event: Reachability-Report

A NF subscribes to this event for “UE Reachability Status Change” to receive the current reachability state of a UE or a group of UEs in the AMF, and report for updated reachability state of a UE or any UE in the group when AMF becomes aware of a reachability state change of the UEs between REACHABLE, UNREACHABLE, REGULATORY_ONLY. The following conditions apply:
the AMF shall send a Reachability Report (“UNREACHABLE”) if the Mobile Reachable Timer expires (see clause 5.4.1.1 of 3GPP TS 23.501) or the UE enters CM-IDLE when it is only registered over the Non-3GPP access (see clause 5.5.3 of 3GPP TS 23.501);
the AMF shall send a Reachability Report (“REGULATORY_ONLY”) if the UE becomes reachable only for regulatory prioritized service (see clause 4.15.4.2 of 3GPP TS 23.502);
the AMF shall send a Reachability Report (“REACHABLE”) when the UE reachability state changes from any of the two above states to REACHABLE.

NOTE 3: The AMF does not send a Reachability Report (“UNREACHABLE”) in particular when the UE enters extended DRX cycle (see clause 5.31.7.2.2.3 of 3GPP TS 23.501 [2]), the UE enters power saving state (see clause 5.31.8 of 3GPP TS 23.501 [2]), the UE enters CM IDLE in MICO mode (see clause 5.4.1.3 of 3GPP TS 23.501 [2]), or when the UE does not respond to a paging request.

An NF subscribes to this event for “UE Reachable for DL Traffic” to receive reports of a UE or a group of UEs when the UE becomes reachable for sending downlink data. In this case, the event is detected when the UE transitions to CM-CONNECTED mode or when the UE will become reachable for paging, as specified in table 4.15.3.1-1, clauses 4.2.5 and 4.3.3 of 3GPP TS 23.502. When reporting the “UE Reachable for DL Traffic”, the AMF shall also indicate the access types through which the UE is reachable.

NOTE 4: The AMF does not send an event report for “UE Reachable for DL Traffic” immediately after an UECM Registration in UDM, if the AMF has previously been indicated that reachability event will be detected at UDM. The UDM will detect the UE reachability from the UECM Registration and send a notification to the NF consumer (unless the UDM is indicated that the UE is currently not reachable, as specified in clause 5.3.2.2.2 of 3GPP TS 29.503), thus the notification report from AMF is omitted.
UE Type: One UE, Group of UEs
Report Type: One-Time Report, Continuous Report
Input: UE ID(s), (optional) Reachability Filter
Notification: UE ID, AMF Id, most recent reachability state (REACHABLE/UNRACHABLE/REGULATORY_ONLY), access type(s) through which the UE is reachable.

### Event: Communication-Failure-Report

A NF subscribes to this event to receive the Communication failure report of a UE or group of UEs or any UE, when the AMF becomes aware of a RAN or NAS failure event.

This event implements the “Communication failure” event in table 4.15.3.1-1 of 3GPP TS 23.502, which is an unexpected termination of the communication.
UE Type: One UE, Group of UEs, any UE
Report Type: One-Time Report, Continuous Report
Input: UE ID(s), “ANY_UE”, optionally filters: Area identifier (a TA list, an area Id or “LADN”)
Notification: UE ID, RAN/NAS release code.

### Event: UEs-In-Area-Report

A NF subscribes to this event to receive the number of UEs in a specific area. A NF may ask AMF for the UEs within the area based on Last Known Location or it may request AMF to actively look for the UEs within the area based on Current Location. This event implements the “Number of UEs present in a geographical area” event in table 4.15.3.1-1 of 3GPP TS 23.502.
UE Type: any UE
Input: “ANY_UE”, optionally Ue in Area filters: UE Aerial Indication, Indication of PDU session established for DNN(s) subject to aerial service
Report Type: One-Time Report (See NOTE 3), Continuous Report (See

NOTE 4), Periodic Report (See NOTE 4) Input: Area identified in a TA List Notification: Number of UEs in the area

NOTE 5: For an Immediate Report, UE Last Known Location is used to count the UEs within the area.

NOTE 6: Support of Continuous Report or Periodic Report should be controlled by operator.

### Event: Loss-of-Connectivity

An NF subscribes to this event to receive the event report of a UE or group of UEs when AMF detects that a target UE is no longer reachable for either signalling or user plane communication. Such condition is identified when Mobile Reachable timer expires in the AMF (see 3GPP TS 23.501 [2]), when the UE detaches and when AMF deregisters from UDM for an active UE. If the UE is already not reachable for either signalling or user plane communication when the event is subscribed, the AMF reports the event directly.

This event implements the “Loss of Connectivity” event in table 4.15.3.1-1 of 3GPP TS 23.502.
UE Type: One UE, Group of UEs.
Report Type: One-Time Report, Continuous Report
Input: UE ID(s)
Notification: UE ID.

### Event: 5GS-User-State-Report

A NF subscribes to this event to receive the 5GS User State of a UE.
UE Type: One UE
Report Type: One-Time Report
Input: UE ID(s)
Notification: UE ID, 5GS User State

### Event: Availability-after-DDN-failure

A NF subscribes to this event to be notified about the Availability of a UE after a DDN failure.
UE Type: One UE, Group of UEs
Report Type: One-Time Report, Continuous Report
Input: UE ID(s)
Notification: UE ID(s)

### Event: Type-Allocation-Code-Report

A NF subscribes to this event to receive the TAC of a UE or a group of UEs or any UE.
UE Type: One UE, Group of UEs, any UE
Report Type: One-Time Report, Continuous Report
Input: UE ID(s), “ANY_UE”, optionally filters: TAI, Area identifier (a TA list, an area Id or “LADN”)
Notification: UE ID(s), TAC(s)

### Event: Frequent-Mobility-Registration-Report

A NF subscribes to this event to receive the number of mobility registration during a period for a UE or a group of UEs or any UE.
UE Type: One UE, Group of UEs, any UE
Report Type: One-Time Report, Continuous Report
Input: UE ID(s), expiry time, “ANY_UE”, optionally filters: Area identifier (a TA list, an area Id or “LADN”)
Notification: UE ID(s), Frequent Registration

### Event: Snssai-TA-Mapping-Report

A NF subscribes to this event to receive the related access type and the list of supported S-NSSAIs.
UE Type: any UE
Report Type: One-Time Report, Continuous Report
Input: Target Area: TA list or “ANY_TAI”, optionally filters: S-NSSAI(s)
Notification: Access type, list of supported S-NSSAIs with an indication of restriction at the AMF

A multicast MBS Session, if lost in an NG-RAN due to NG-RAN failure or restart, may not be possible to be restored, and consequently the joined UEs in the coverage of that NG-RAN may not be able to receive the multicast MBS service.

When a NG-RAN has restarted, it will lose all its session contexts including those MBS multicast sessions served by the NG-RAN. As specified in clause 7.2.1 of TS 23.247 (see also section 2.1.1.5), only the SMF knows which UE has joined an MBS multicast session, i.e., whether a PDU session is associated with an multicast session. So, after a NG-RAN restart, only the SMF is able to restore the MBS Session in NG-RAN. So, the SMF need to learn NG-RAN failure or restart. In some embodiments of the present disclosure, an NG-RAN failure or restart can be detected via control plane and/or user plane.

In some embodiments, NG-RAN failure/restart may be detected via Control Plane and restored. After being recovered from a restart or a (partial) failure, the NG-RAN may notify the (partial) failure or restart to the AMF using NG SETUP Request or NG RESET as specified in 3GPP TS 38.413 as described with reference to FIG. 9.

As specified in clause 8.2 of RFC 4960 for SCTP (see section 2.1.4), which is the transport layer protocol for the NGAP over N2 interface, the AMF is also possible to detect a NG-RAN failure with restart. Therefore, detection of NG-RAN failure with or without restart can be done by the AMF WITHOUT any protocol impact per existing specification.

The AMF may inform MB-SMF of NG-RAN restart/failure, and the MB-SMF may instruct the MB-UPF to clean N3mb tunnel info if applicable.

Scenario-1: AMF informs SMF of the NG-RAN restart/failure

Once NG-RAN restart/failure is detected in the AMF, in some embodiments, such failure can be reported by the AMF to the SMF using different options as follows:
Per UE signaling message:
   AMF-SMF-option-1: via per PDU Session signaling, enhanced with a new indication of NG-RAN restart/failure.
   AMf-SMF-option-2: use the mechanism of Nsmf_Ng_Reset or another new service operation of SMF, one message for one UE.
One message for all UEs camping on the NG-RAN that experience restart/failure:
   AMF-SMF-Option-3: use the mechanism of Nsmf_Ng_Reset or another new service operation of SMF, one message includes a list of UEs served by the NG-RAN that experienced failure or restart
   AMF-SMF-Option-4: the SMF may subscribe a new NG-RAN failure or restart event offered by Namf_EventExposure service, and the AMF may report, to the SMF, NG-RAN restart/failure Event if those PDU sessions (with active user plane RAN resource) are anchored in that SMF. When reporting such event, the AMF shall also provide the SMF with a list of UEs and their PDU sessions which are affected by the NG-RAN failure, (For the detail of AMF event, see description below for detail).

If per UE signaling message is used by AMF to inform the SMF of the NG-RAN restart, the SMF may instruct the UPF to release the N3 tunnel if any. If the affected PDU Session is associated with an active MBS Session, the SMF may initiate PDU Session Modification procedure to provide the UE join information to the NG-RAN.

If one message for a list of UEs is used by AMF to inform the SMF of the NG-RAN restart, the SMF may instruct the UPF to release the N3 tunnels for the affected UE/PDU Session(s), and then SMF may initiate PDU Session Modification procedure for each UE, or the SMF may initiate enableGroupReachability request to the AMF with list of UEs and PDU Session IDs associated with an active MBS Session, as will be detailed below.

In some embodiments, NG-RAN failure/restart may be detected via User Plane and restored. Both UPF and MB-UPF can detect NG-RAN failure/restart.

### Part-1) the Restart or Failure of NG-RAN Detected by the UPF:

UPF receiving GTP-U Error Indication

The restarted NG-RAN will not recognize the DL F-TEID allocated by the NG-RAN before its restart for a given PDU session (which is associated with the MBS session), hence the NG-RAN will send GTP-U Error Indication. The GTP-U Error Indication will be further reported to the SMF. The SMF will be able to know which PDU session is affected by the NG-RAN restart.

Then SMF then release the N3 tunnel info.

If the affected PDU Session is associated with an active MBS Session, the SMF invokes Namf_Communication_N1N2Message Transfer message to provide the UE join information to NG-RAN. A new indication of NG-RAN restart is also included in N2 SM container of N1N2MessageTransfer message.
UPF perform path management procedure towards NG-RAN

The UPF may send Echo Request message to NG-RAN periodically to detect liveness of a GTP-U path identified by the IP Address within the DL F-TEID. So, the UPF will be able to detect NG-RAN restart or GTP-U Path failure towards the NG-RAN. The UPF may report the GTP-U path failure or NG-RAN restart to the SMF. Then the SMF may need to figure out the PDU sessions affected by the NG-RAN restart or failure, and request AMF to perform paging for the affected UE(s), indicating that NG-RAN failure/restart, as described below.

Part-2) the NG-RAN restart or failure of NG-RAN detected by the MB-UPF:

When unicast transport over N3mb is used:
The restarted NG-RAN will not recognize the DL F-TEID allocated by the NG-RAN before its restart, hence the NG-RAN will send GTP-U Error Indication for any DL MBS Session data. The GTP-U Error Indication will be further reported to the MB-SMF.
The MB-UPF will send periodically Echo Request message to detect liveness of a GTP-U path identified by the IP Address within the DL F-TEID. So, the MB-UPF will be able to detect GTP-U Path failure towards the NG-RAN and if the failure is detected, the MB-UPF will also reported to the MB-SMF.

When multicast transport over N3mb is used:
The NG-RAN will JOIN the multicast group, i.e. MBS session data will be retrieved from the lower layer Source Specific Multicast address allocated by the MB-UPF. The MB-UPF will be UNAWARE if there is any NG-RAN restart or failure.

Here the MB-UPF may need an addition transport IP address.

When the MB-SMF is notified by the MB-UPF about the NG-RAN restart/failure, the MB-SMF may instruct the MB-UPF to clean the N3mb DL Tunnel info if available.

In both options above (control plane option and user plane option), it is also possible to let MB-SMF to notify SMF to trigger the restoration, after MB-SMF is informed by the AMF (control plane option) or MB-UPF (user plane option).

In this scenario, when the MB-SMF is notified by the MB-UPF about the NG-RAN restart/failure and if the MB-SMF has the mapping information between NG-RAN ID and NG-RAN's IP address, the following is performed:
the MB-SMF informs the SMF about the NG-RAN has restarted or failed in the following way:
   SMF finds the AMFs using NG-RAN ID as input parameter by querying NRF (implying that NG-RAN ID needs to be included in the AMF profile).
   the SMF then sends to the AMF(s) the list of joined UEs and IDs of PDU Sessions associated with an active MBS Session. The SMF also includes indication that there is NG-RAN restart/failure. The AMF then figures out the list of UEs belonging to the failed/restarted NG-RAN, and pages those UE. After the UEs are back, the SMF add those UEs back to NG-RAN together with an indication of NG-RAN restart/failure in N2 message container.

In some embodiments, to restore the multicast MBS Session, MB-SMF may need to be aware of NG-RAN ID and maintain a mapping between NG-RAN and NG-RAN Tunnel Info or IP address. When NG-RAN failure or restarted is detected, the SMF may be informed. The SMF may release the N3 tunnel towards the NG-RAN if needed, and then provide the info of joined UE to NG-RAN again for active MBS Session.

With some embodiments of the present disclosure, if a multicast MBS Session got lost in NG-RAN due to NG-RAN restart or failure, it can be restored by 5GC. Therefore, the multicast MBS service can be restored so that the UEs that are within the area served by the restarted NG-RANs can continue to receive MBS service.

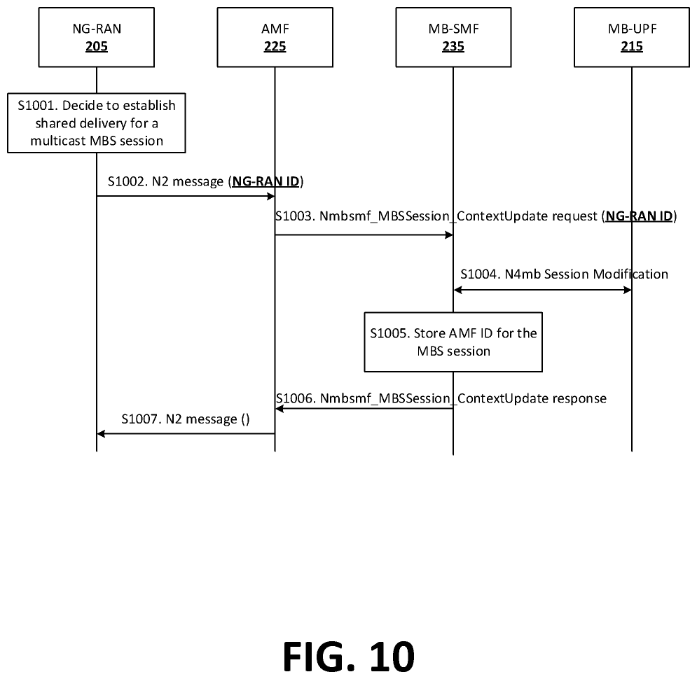

FIG. 10 is a diagram illustrating an exemplary procedure for establishing share delivery toward NG-RAN node according to some embodiments of the present disclosure.

As shown in FIG. 10, the additional parameter NG-RAN ID may be provided either by NG-RAN or by AMF. In the following cases, the shared tunnel for shared delivery may be established between the NG-RAN and MB-UPF:
The first UE is included in the context of the MBS session in the NG-RAN.

NOTE 1: When the MBS session is deactivated, if there is at least one UE joining the MBS session is in connected mode in the NG-RAN, the shared delivery is not released.

NOTE 2: Share delivery establishment procedures may be used when MBS supporting NG-RAN node(s) get involved in the MBS session upon MBS session activation.
Handover to the target NG-RAN when the shared delivery tunnel is not established in the target RAN node for this MBS session.

At step S1001, an NG-RAN node 205 may decide to establish shared delivery for an MBS session when it serves at least one UE within the MBS session. For location dependent services, the NG-RAN node 205 may need to establish shared delivery for the location dependent contents of an MBS session if it serves at least one UE assigned to an MBS session ID and area session ID.

At step S1002, the NG-RAN 205 may send an N2 MBS Session request message (MBS Session ID, N2 SM information (MBS Session ID, [unicast Tunnel Info], [Area Session ID]) towards an AMF 225.

If the NG-RAN node 205 is configured to use unicast transport for the shared delivery, it may allocate a GTP tunnel endpoint and provide the unicast Tunnel Info in the request, which includes the GTP tunnel endpoint and NG-RAN node address. For location dependent MBS services, the NG-RAN node 205 may also provide the Area Session ID.

Further, the NG-RAN 205 may also include NG-RAN ID in the message.

At step S1003, the AMF 225 may select an MB-SMF 235 serving the multicast session using the NRF discovery service. It may invoke

Nmbsmf_MBSSession_ContextUpdate request (MBS Session ID, N2 SM information) to the MB-SMF 235.

The AMF 225 may store the information for the NG-RAN nodes (e.g. NG-RAN node ID) for the subsequent signaling related to the MBS Session.

Further, the AMF 225 may also include NG-RAN ID in the message.

At step S1004, if the MB-SMF 235 received unicast Tunnel Info in step S1003, it may configure an MB-UPF 215 to send multicast data for the multicast session (or location dependent content of the multicast session if an area session ID was received) towards that GTP tunnel endpoint via unicast transport.

At step S1005, the MB-SMF 235 may store the AMF 225 in the multicast session context (or location dependent part of the multicast session context if an area session ID was received) to enable subsequent signalling towards that NG-RAN node.

Further, the MB-SMF 235 may maintain the mapping between the NG-RAN ID and the DL N3mb Tunnel Info (i.e. NG-RAN N3mb Tunnel Info)

At step S1006, the MB-SMF 235 may send Nmbsmf_MBSSession_ContextUpdate response (MBS Session ID, N2 SM information ([TMGI], multicast QOS flow information, [transport multicast address], [multicast Tunnel Info]) to the AMF 225. If the MB-SMF 235 did not receive unicast Tunnel Info in step S1003, it may provide the transport multicast address (e.g. a LL SSM) and a GTP tunnel endpoint for multicast transport of the shared delivery.

At step S1007, the AMF 225 may send an N2 MBS Session response (MBS Session ID, N2 SM information) to the NG-RAN node 205. If the NG-RAN node 205 receives the transport multicast address and multicast Tunnel Info of the shared delivery, it may use the transport multicast address to join the multicast transport distribution.

As an embodiment of the AMF-SMF-Option-4 mentioned above, a new AMF Event may be provided or an existing AMF event may be re-used with extensions:

The following Communication-Failure-Report may be used:

### (Reuse) Event: Communication-Failure-Report

A NF subscribes to this event to receive the Communication failure report of a UE or group of UEs or any UE, when the AMF becomes aware of a RAN or NAS failure event.
This event implements the “Communication failure” event in table 4.15.3.1-1 of 3GPP TS 23.502, which is an unexpected termination of the communication.
UE Type: One UE, Group of UEs, any UE
Report Type: One-Time Report, Continuous Report
Input: UE ID(s), “ANY_UE”, optionally filters: Area identifier (a TA list, an area Id or “LADN”)
Notification: UE ID, RAN/NAS release code.

Or a new event:

### (New) Event: NG-RAN-Failure-Report

A NF subscribes to this event to receive the NG-RAN failure-report for any UE having resource context created in the NF service consumer, when the AMF becomes aware of a NG-RAN failure or restart. For example, a SMF may subscribe this event to the AMF, to request AMF to report such event if those PDU sessions with user plane resource affected by the NG-RAN failure/restart are anchored in that SMF.
UE Type: any UE
Report Type: Continuous Report
Input: “ANY_UE”, NF service consumer service instance Id, e.g. smfServiceInstanceId, or authority of resource URI.
Notification: UE ID(s), NG-RAN restart or failure indication.

NF service consumer service instance Id, or authority of resource URI is to enable AMF to determine to which SMF those affected PDU sessions pertain, so that the AMF can send notification report to those SMFs.

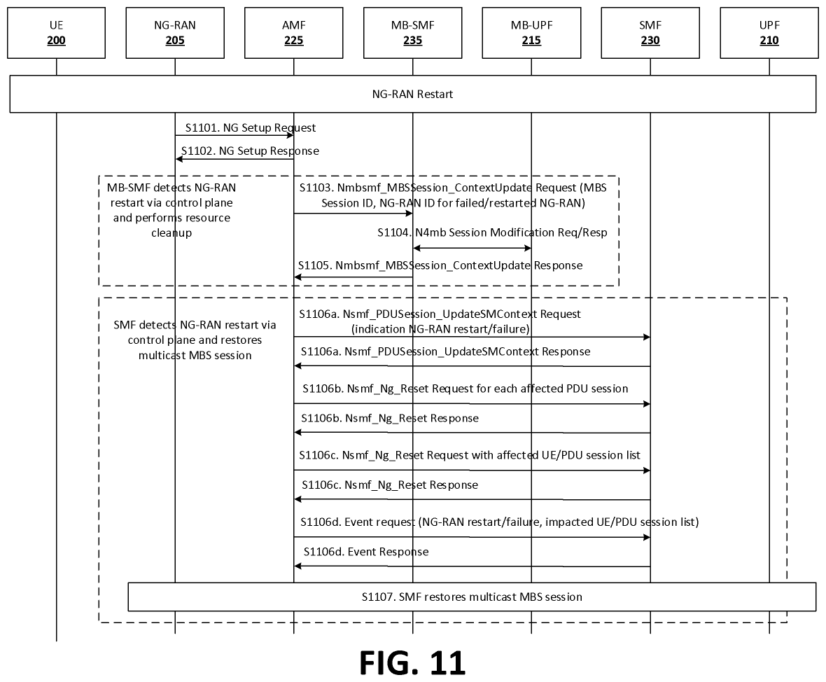

In some embodiments, some methods for detecting NG-RAN failure/restart via Control plane solution and restoration may be described with reference to FIG. 11. In some embodiments, at failure of NG-RAN or after NG-RAN restart, NG-RAN may send NG Setup Request or NG Reset Request to AMF.

FIG. 11 is a diagram illustrating multiple exemplary methods for detecting a failure and/or restart of a RAN node in CP according to some embodiments of the present disclosure.

As shown in FIG. 11, at step S1101, the NG-RAN 205 may send NG Setup Request or NG Reset Request to the AMF 225.

At step S1102, the AMF 225 may respond NG Setup Response or NG Reset Response to the NG-RAN 205.

The first method for detecting NG-RAN failure/restart may be related to the steps S1103 through S1105.

At step S1103, the AMF 225 may identify the Multicast MBS sessions in which the NG-RAN 205 is involved. For each Multicast MBS session, the AMF 225 may inform the MB-SMF 235 that a specific NG-RAN 205 has experienced failure or restart by invoking Nmbsmf_MBSSession_ContextUpdate including MBS Session ID and NG-RAN ID.

At step S1104, for unicast transport over N3mb, the MB-SMF 235 may send N4mb Session Modification Request to the MB-UPF 215 to release the N3mb DL Tunnel. The MB-UPF 215 may release the N3mb DL tunnel and sends N4mb Session Modification Response to the MB-SMF 235.

At step S1105, the MB-SMF 235 may send Nmbsmf_MBSSession_ContextUpdate response to the AMF 225.

The second through fifth methods for detecting NG-RAN failure/restart may be related to the steps S1106a through S1106d.

At step S1106, the AMF 215 may identify UEs served by the NG-RAN 205 that experienced failure or restart.

At step S1106a, the AMF 215 may inform the SMF 230 of NG-RAN failure/restart by sending Nsmf_PDUSession_UpdateSMContext request to the relevant SMF 230 for each PDU session.

At step S1106b, the AMF 215 may inform the SMF 230 of the NG-RAN failure/restart using Nsmf_Ng_Reset or another new SMF service operation for each affected PDU session.

At step S1106c, the AMF 215 may inform the SMF 230 of the NG-RAN failure/restart using Nsmf_Ng_Reset with the affected UE/PDU session list.

At step S1106d, the AMF 215 may send NG-RAN restart event to the SMF 230 with the impacted UE/PDU session list.

Upon detection of the NG-RAN failure/restart, at step S1107, for PDU Sessions of UEs that have joined any MBS Sessions, the SMF 230 may perform multicast MBS session restoration as described with reference to FIG. 13.

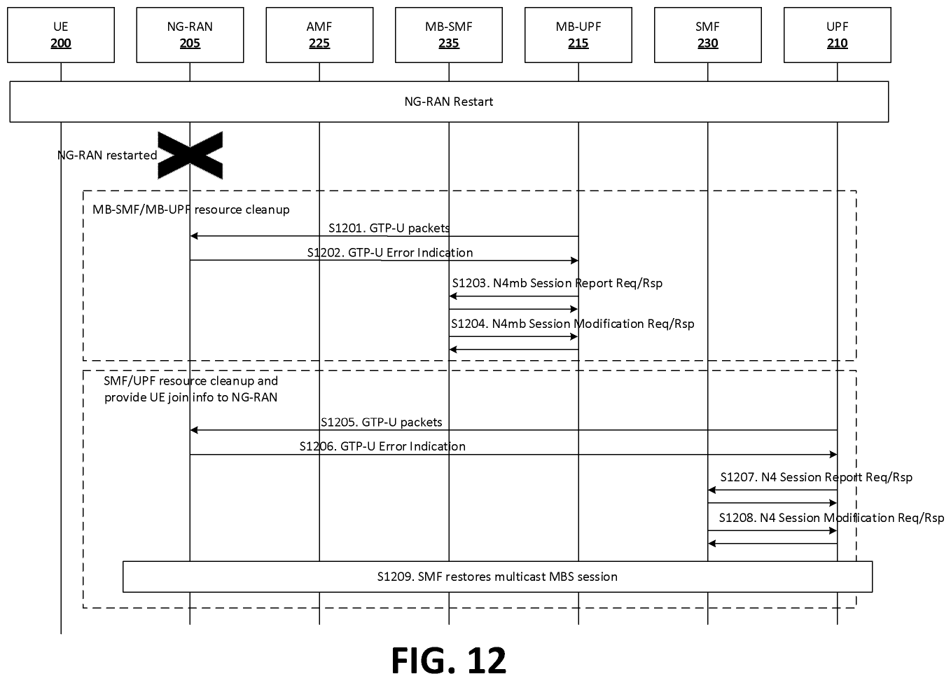

In some embodiments, some methods for detecting NG-RAN failure/restart via User Plane solution and restoration may be described with reference to FIG. 12. FIG. 12 is a diagram illustrating multiple exemplary methods for detecting a failure and/or restart of a RAN node in UP according to some embodiments of the present disclosure. As shown in FIG. 12, user plane failure detection may consist of two parts:

Part-1: (step S1201 to step S1204), the MB-UPF 215 may detect and report loss of GTP-U context, and the MB-UPF 215 may detect/report path failure towards NG-RAN or NG-RAN restart.

The restarted NG-RAN 205 will not recognize the DL F-TEID in GTP-U packets received at step S1201, the DL F-TEID being allocated by the NG-RAN 205 before its restart, hence the NG-RAN 205 will send GTP-U Error Indication for any DL MBS Session data at step S1202. The GTP-U Error Indication may be further reported to the MB-SMF 235 at step S1203.

Besides the error indication, it is also possible to have the user plane path management. The MB-UPF 215 may send periodically Echo Request message to detect liveness of a GTP-U path identified by the IP Address within the DL F-TEID. So, the MB-UPF 215 may be able to detect GTP-U Path failure towards the NG-RAN and if the failure is detected, the MB-UPF 215 may also reported to the MB-SMF.

For unicast transport of N3mb, the MB-UPF 215 may get the transport IP address from the DL tunnel. For multicast transport of N3mb, the MB-UPF 215 may need an addition transport IP address.

After reporting user plane path failure, the MB-SMF 235 may determine the affected PFCP sessions which are associated with MBS sessions.

Part-2: (step S1205 to step S1208) The UPF 210 may detect and report loss of GTP-U context, and UPF may detect/report path failure towards NG-RAN or NG-RAN restart, as specified in TS 23.527 clause 5.2.

The restarted NG-RAN will not recognize the DL F-TEID in the GTP-U packets received at step S1205, the DL F-TEID being allocated by the NG-RAN 205 before its restart for a given PDU session (which is associated with the MBS session), hence the NG-RAN 205 will send GTP-U Error Indication. The GTP-U Error Indication may be further reported to the SMF 230. The SMF 230 may be able to know which PDU session is affected by the NG-RAN restart.

Besides the error indication, it is possible to have the user plane path management. The UPF 210 may send periodically Echo Request message to detect liveness of a GTP-U path identified by the IP Address within the DL F-TEID. So, the UPF 210 may be able to detect GTP-U Path failure towards the NG-RAN 205 and if the failure is detected, the UPF 210 may also report to the SMF 230.

After reporting user plane path failure, the SMF 230 may determine the affected PFCP sessions which are associated with MBS sessions.

At step S1209, the SMF 230 may restore multicast MBS session as will be described with reference to FIG. 13.

FIG. 13 is a diagram illustrating an exemplary procedure for SMF initiated multicast MBS session restoration according to some embodiments of the present disclosure. As shown in FIG. 13, an SMF 230 triggered Restoration procedure without notification from MB-SMF 235 is provided. The restoration procedure is similar as step S703 to step S710b) in the MBS session activation procedure shown in FIG. 7A and FIG. 7B, and therefore a detailed description of same steps is omitted for simplicity. Further, please note that this procedure may be a specific implementation of the step S1107 shown in FIG. 11 and/or the step S1209 shown in FIG. 12.

As shown in FIG. 13, if the SMF 230 is informed by a UE list (for example, steps S1106c, S1106d in FIG. 11 and user plane path failure in FIG. 12), step S1301 can be triggered, in Namf_MT_EnableGroupReachability request sent from the SMF 230 to the AMF 225, a NG-RAN restart indication may be included. If the UEs are in CM-IDLE mode due to NG-RAN restart, the AMF 225 may accept the request and perform the step S1303 for those IDLE UEs. Otherwise, the AMF 225 can reject the request or pend the request till the NG-RAN Setup or Reset is received from the NG-RAN 205.

If the SMF 230 is informed in per UE manner (for example, steps S1106a, S1106b in FIG. 11 or error indication in FIG. 12), the SMF 230 may skip step S1301 and perform step S1302b directly.

In step S1302b, S1305b, S1306b, in N2 message container, the SMF 230 may need to include a NG-RAN restart indication flag in

Namf_Communication_N1N2Message Transfer request or the Nsmf_PDUSession_UpdateSMContext response to the AMF 215, so that in step S1307, the NG-RAN restart indication flag can be passed to NG-RAN 205. Based on this flag, the NG-RAN 205 can take actions to ensure the UE is added into the multicast MBS session distribution.

FIG. 14 is a diagram illustrating an exemplary procedure for MB-SMF initiated multicast MBS session restoration according to some embodiments of the present disclosure. As shown in FIG. 14, an SMF triggered Restoration procedure with notification from the MB-SMF 235 is provided. The restoration procedure is similar as step S701 to step S710b) in the MBS session activation procedure shown in FIG. 7A and FIG. 7B, and therefore a detailed description of same steps is omitted for simplicity. Further, please note that this procedure may be utilized when the MB-SMF detects the NG-RAN failure/restart, for example after the step S1103 in FIG. 11 or after the step S1203 in FIG. 12.

As shown in FIG. 14, after detecting the NG-RAN 205 restart/failure at step S1401, the MB-SMF 235 may notify the SMF 230 about the NG-RAN restart. In this embodiment, the SMF 230 can perform the restoration based on the notification from the MB-SMF 235, instead of from the AMF 215 or the UPF 210.

At step S1402, the MB-SMF 235 may inform all subscribed SMFs about the NG-RAN restart via Nmbsmf_MBSSession_ContextStatusNotify. In the request, the MB-SMF 235 may need to inform the SMF 230, and the notification is to restore the MBS session due to NG-RAN restart and include the NG-RAN ID in the message.

At step S1403, the SMF 230 may discover AMFs which connected to the restarted NG-RAN 205 by querying NRF using the NG-RAN ID. After that, the SMF 230 may send Namf_MT_EnableGroupReachability request to those AMFs providing the UE list who joined the MBS session and served by the AMF 215. The SMF 230 may need to include a NG-RAN restart indication flag and the restarted NG-RAN ID.

At step S1404, the AMF 215 may determine the UEs impacted by the NG-RAN 205 based on the NG-RAN ID, and trigger the step S1405 for those UEs.

In step S1404b, S1407b, S1408b, in N2 message container, the SMF may need to include a NG-RAN restart indication flag in Namf_Communication_N1N2MessageTransfer request or the Nsmf_PDUSession_UpdateSMContext response to the AMF 215, so that in step S1409, the NG-RAN restart indication flag can be passed to NG-RAN 205. Based on this flag, the NG-RAN 205 can take actions to ensure the UE is added into the multicast MBS session distribution.

With some of the embodiments described above, if a multicast MBS Session got lost in NG-RAN due to NG-RAN restart or failure, it can be restored by 5GC. Therefore, the multicast MBS service can be restored so that the UEs that are within the area served by the restarted NG-RANs can continue to receive MBS service.

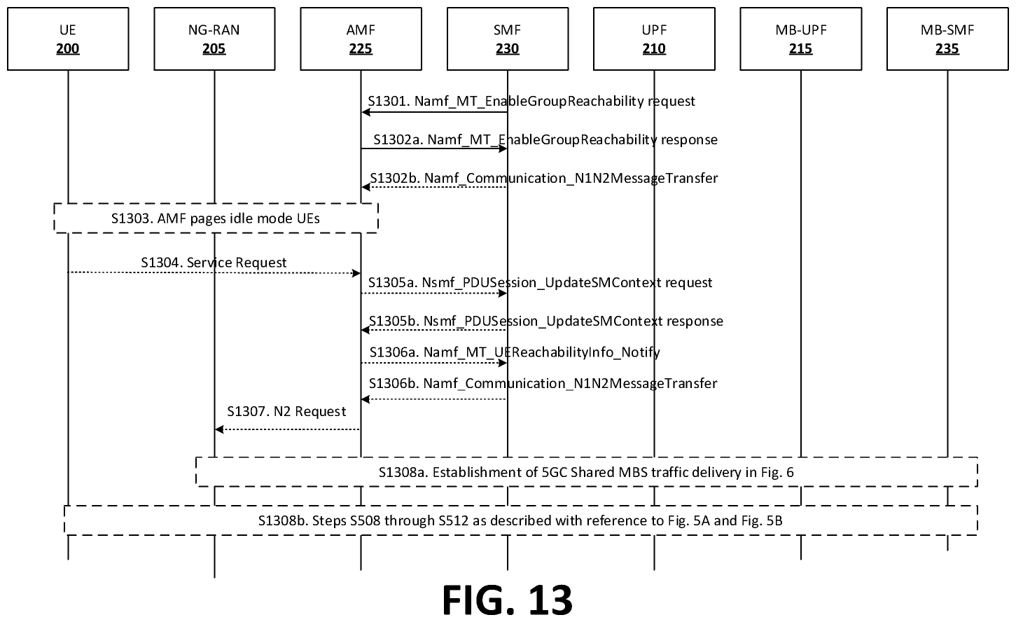

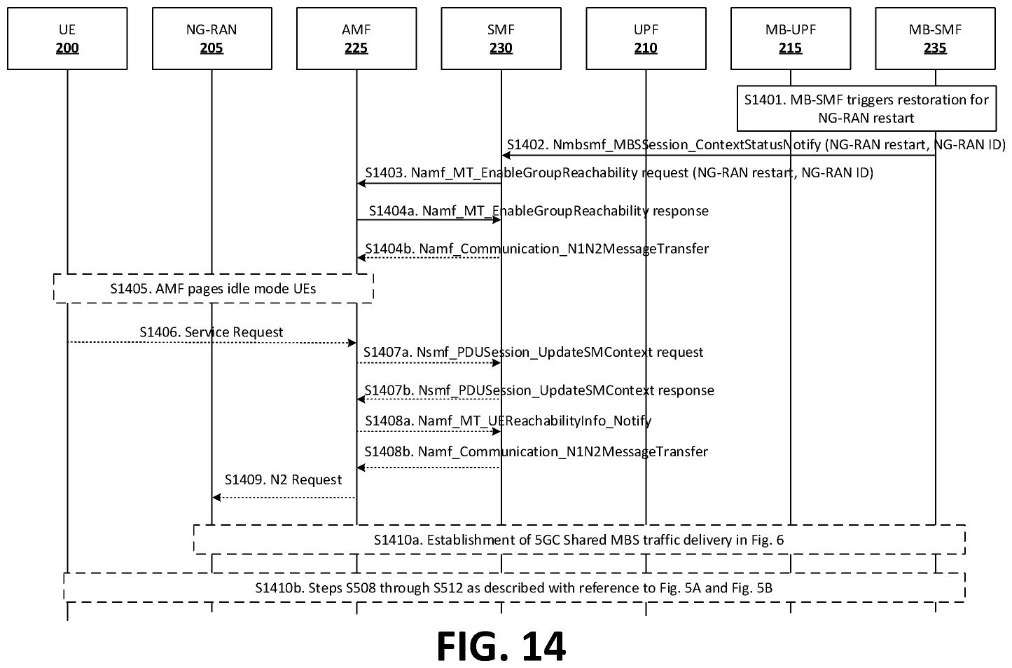

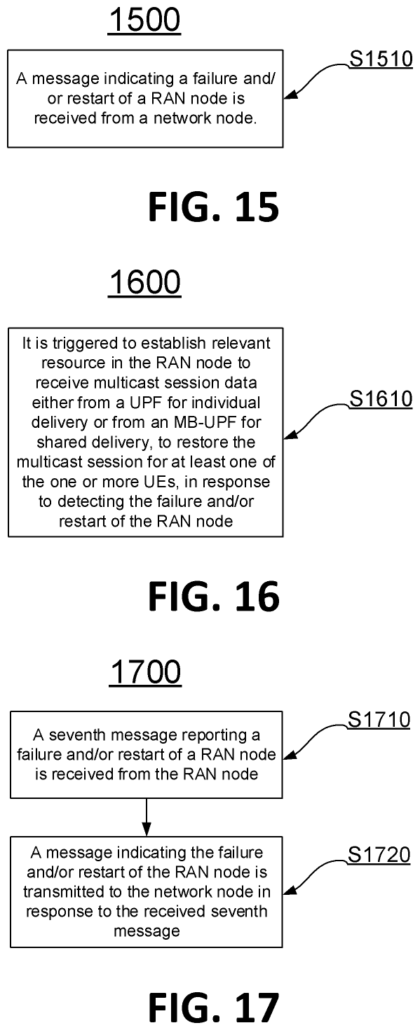

FIG. 15 is a flow chart of an exemplary method 1500 at an SMF for detecting a failure and/or restart of a RAN node that serves one or more UEs for a multicast session is provided according to an embodiment of the present disclosure. The method 1500 may be performed at a first network node (e.g., the SMF 230 shown in FIG. 2). The method 1500 may comprise step S1510. However, the present disclosure is not limited thereto. In some other embodiments, the method 1500 may comprise more steps, different steps, or any combination thereof. Further the steps of the method 1500 may be performed in a different order than that described herein. Further, in some embodiments, a step in the method 1500 may be split into multiple sub-steps and performed by different entities, and/or multiple steps in the method 1500 may be combined into a single step.

The method 1500 may begin at step S1510 where a message indicating a failure and/or restart of the RAN node may be received from a network node.

In some embodiments, the network node comprises at least one of: an AMF; a UPF; and an MB-SMF. In some embodiments, the message comprises at least one of: an Nsmf_PDUSession_UpdateSMContext request message that is transmitted from an

AMF for a PDU session associated with one of the UEs; a first message for one or more UEs and/or one or more PDU sessions, the first message being a request message transmitted from an AMF for requesting for a service operation provided by the SMF that is not defined in the 3GPP TS 23.502, V17.3.0 or any of its prior releases; a second message for a list of one or more UEs and/or a list of one or more PDU sessions, the second message being an event notifying message from an AMF for notifying the SMF of an event of a failure and/or restart of the RAN node; a third message for a PDU session, the third message being a session report message from a UPF for reporting the failure and/or restart of the RAN node; a fourth message for a node level event, the fourth message being a node report message from a UPF for reporting the failure and/or restart of the RAN node; and a fifth message for the multicast session, the fifth message being transmitted from an MB-SMF associated with the multicast session.

In some embodiments, the first message indicates one of: a single UE and/or a single PDU session that are impacted by the failure and/or restart of the RAN node; and a list of one or more UEs and/or a list of one or more PDU sessions that are impacted by the failure and/or restart of the RAN node. In some embodiments, the second message indicates one of: a Communication-Failure-Report event; and an AMF event that is not defined in the 3GPP TS 23.502, V17.3.0 or any of its prior releases or 3GPP TS 29.518 V17.4.0 or any of its prior releases. In some embodiments, when the message comprises the second message, the method further comprises, before the step of receiving the message: transmitting, to the AMF, a message for subscribing the event. In some embodiments, the message for subscribing the event comprises at least one of: IDs of one or more of the UEs or an “any UE” indication; one or more area identifiers; NF service consumer service instance ID; and authority of resource URI. In some embodiments, the event comprises at least one of: a RAN/NAS release code; one or more UE IDs; one or more PDU session IDs; and an NG-RAN restart or failure indication.

In some embodiments, the third message is a PFCP session report message comprising a TEID and an IP address pertaining to the failed RAN node. In some embodiments, the fourth message is a PFCP node report message comprising an IP address pertaining to the failed RAN node. In some embodiments, the fifth message is an Nmbsmf_MBSSession_ContextStatusNotify message comprising an indicator indicating the failure and/or restart of the RAN node and/or an ID of the RAN node.

FIG. 16 is a flow chart of an exemplary method 1600 at an SMF for restoring a multicast session for one or more UEs that are served by a RAN node experienced a failure and/or restart is provided according to an embodiment of the present disclosure. The method 1600 may be performed at a first network node (e.g., the SMF 230 shown in FIG. 2). The method 1600 may comprise step S1610. However, the present disclosure is not limited thereto. In some other embodiments, the method 1600 may comprise more steps, different steps, or any combination thereof. Further the steps of the method 1600 may be performed in a different order than that described herein. Further, in some embodiments, a step in the method 1600 may be split into multiple sub-steps and performed by different entities, and/or multiple steps in the method 1600 may be combined into a single step.

The method 1600 may begin at step S1610 where it may be triggered to establish relevant resource in the RAN node to receive multicast session data either from a UPF for individual delivery or from an MB-UPF for shared delivery, to restore the multicast session for at least one of the one or more UEs, in response to detecting the failure and/or restart of the RAN node.

In some embodiments, the step of triggering establishing the relevant resource in the RAN node comprises: transmitting, to the RAN node via the AMF, a sixth message to cause the RAN node to initiate the establishment of the relevant resource for the multicast session. In some embodiments, the sixth message comprises an indicator indicating the failure and/or restart of the RAN node and/or an ID of the RAN node. In some embodiments, before the step of triggering establishing the relevant resource in the RAN node, the method further comprises: determining the one or more UEs that joined the multicast session and that are impacted by the failure and/or restart of the RAN node. In some embodiments, the step of determining the one or more UEs comprises at least one of: determining the one or more UEs that are indicated in a received message from the AMF, the received message further indicating the failure and/or restart of the RAN node; and retrieving one or more UEs which have the same IP address in their tunnel endpoint for the downlink tunnel in the RAN node to receive multicast session data when the RAN failure or restart is reported by the UPF.

In some embodiments, the method further comprises: transmitting, to an AMF, a request message to request the AMF to page the one or more UEs to bring these UEs into CM-CONNECTED mode, the request message comprising an indicator indicating the failure and/or restart of the RAN node; and receiving, from the AMF, a response message for indicating which of the one or more UEs is or are in CM-CONNECTED mode. In some embodiments, before the step of triggering establishing the relevant resource in the RAN node, the method further comprises: receiving, from an MB-SMF, a fifth message indicating a detected failure and/or restart of the RAN node and an ID of the RAN node; transmitting, to a Network Repository Function (NRF), a request message to discover a list of AMFs having association with the RAN node; receiving, from the NRF, a response message containing a list of AMFs; selecting an AMF from the list of AMFs; transmitting, to the AMF, a request message for querying the one or more UEs that are impacted by the failure and/or restart of the RAN node and/or for requesting AMF to page the one or more UEs, the request message comprising an indicator indicating the failure and/or restart of the RAN node and/or an ID of the RAN node; and receiving, from the AMF, a response message comprising the one or more UEs and/or acceptance of paging. In some embodiments, the failure and/or restart of the RAN node is detected by the SMF with the method described with reference to FIG. 15.

FIG. 17 is a flow chart of an exemplary method 1700 at an AMF for facilitating a network node in detecting a failure and/or restart of a RAN node that serves one or more UEs for a multicast session is provided according to an embodiment of the present disclosure. The method 1700 may be performed at a second network node (e.g., the AMF 225 shown in FIG. 2). The method 1700 may comprise steps S1710 and S1720. However, the present disclosure is not limited thereto. In some other embodiments, the method 1700 may comprise more steps, less steps, different steps, or any combination thereof. Further the steps of the method 1700 may be performed in a different order than that described herein. Further, in some embodiments, a step in the method 1700 may be split into multiple sub-steps and performed by different entities, and/or multiple steps in the method 1700 may be combined into a single step.

The method 1700 may begin at step S1710 where a seventh message reporting a failure and/or restart of the RAN node may be received from the RAN node.

At step S1720, a message indicating the failure and/or restart of the RAN node may be transmitted to the network node in response to the received seventh message

In some embodiments, the network node comprises at least one of: an SMF; and an MB-SMF. In some embodiments, the message comprises at least one of: an Nmbsmf_MBSSession_ContextUpdate request message that is transmitted to an MB-SMF for the multicast session; an Nsmf_PDUSession_UpdateSMContext request message that is transmitted to an SMF for a PDU session associated with one of the UEs; a first message for one or more UEs and/or one or more PDU sessions, the first message being a request message transmitted to an SMF for requesting for a service operation provided by the SMF that is not defined in the 3GPP TS 23.502, V17.3.0 or any of its prior releases; and a second message for a list of one or more UEs and/or a list of one or more PDU sessions, the second message being an event notifying message from the AMF to an SMF for notifying the SMF of a failure and/or restart event of the RAN node.

In some embodiments, the Nmbsmf_MBSSession_ContextUpdate request message indicates at least one of: an ID of the multicast session; and an ID of the RAN node that experienced a restart and/or failure. In some embodiments, the first message indicates one of: a single UE and/or a single PDU session that are impacted by the failure and/or restart of the RAN node; and a list of one or more UEs and/or a list of one or more PDU sessions that are impacted by the failure and/or restart of the RAN node. In some embodiments, the second message indicates one of: a Communication-Failure-Report event; and an AMF event that is not defined in the 3GPP TS 23.502, V17.3.0 or any of its prior releases or 3GPP TS 29.518 V17.4.0 or any of its prior releases. In some embodiments, when the message comprises the second message, the method further comprises, before the step of transmitting the message: receiving, from the SMF, a message for subscribing the event, wherein before the step of transmitting the message, the method further comprises: determining the SMF as a destination, which is to be notified of the event, at least based on the received message for subscribing the event.

In some embodiments, the message for subscribing the event comprises at least one of: IDs of the one or more UEs or an “any UE” indication; one or more area identifiers; NF service consumer service instance Id; and authority of resource URI. In some embodiments, the event comprises at least one of: a RAN/NAS release code; one or more UE IDs; one or more PDU session IDs; and an NG-RAN restart or failure indication. In some embodiments, the seventh message comprises at least one of: an NG Setup request message; and an NG Reset request message.

In some embodiments, before the step of receiving the seventh message, the method further comprises: receiving, from the RAN node, an eighth request message requesting for establishing shared delivery toward the RAN node for the multicast session, the eighth request message comprising an N2 container, the N2 container comprising an ID of the RAN node that experienced a failure and/or restart and further comprising a transport IP address when multicast transport is used or an N3mb tunnel endpoint information when unicast transport is used; and transmitting, to the MB-SMF, a ninth request message requesting for establishing shared delivery toward the RAN node for the multicast session at least based on the eighth request message, the ninth request message comprising the ID of the RAN node that is inserted by the AMF and the N2 container; receiving, from the MB-SMF, a ninth response message indicating whether the shared delivery is established successfully or not and/or indicating information for establishing the shared delivery; and transmitting, to the RAN node, an eighth response message indicating whether the shared delivery is established successfully or not and/or indicating information for establishing the shared delivery at least based on the ninth response message.

In some embodiments, the eighth request message is an N2 MBS Session request message, the eighth response message is an N2 MBS Session response message, the ninth request message is an Nmbsmf_MBSSession_ContextUpdate request message, and the ninth response message is an Nmbsmf_MBSSession_ContextUpdate response message.

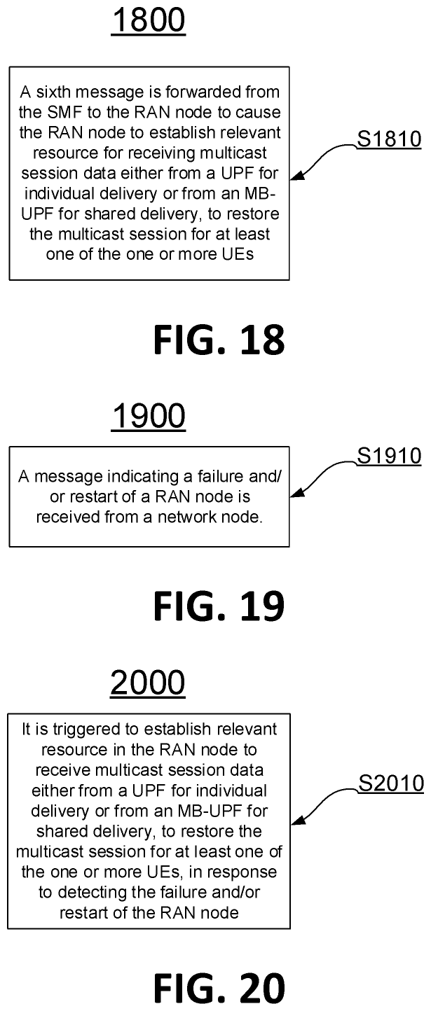

FIG. 18 is a flow chart of an exemplary method 1800 at an AMF for facilitating an SMF in restoring a multicast session for one or more UEs that are served by a RAN node experienced a failure and/or restart is provided according to an embodiment of the present disclosure. The method 1800 may be performed at a second network node (e.g., the AMF 225 shown in FIG. 2). The method 1800 may comprise step S1810. However, the present disclosure is not limited thereto. In some other embodiments, the method 1800 may comprise more steps, different steps, or any combination thereof. Further the steps of the method 1800 may be performed in a different order than that described herein. Further, in some embodiments, a step in the method 1800 may be split into multiple sub-steps and performed by different entities, and/or multiple steps in the method 1800 may be combined into a single step.

The method 1800 may begin at step S1810 where a sixth message may be forwarded from the SMF to the RAN node to cause the RAN node to establish relevant resource for receiving multicast session data either from a UPF for individual delivery or from an MB-UPF for shared delivery, to restore the multicast session for at least one of the one or more UEs.

In some embodiments, the sixth message comprises an indicator indicating the failure and/or restart of the RAN node and/or an ID of the RAN node. In some embodiments, before the step of forwarding the sixth message, the method further comprises: receiving, from the SMF, a request message to request the AMF to page the one or more UEs to bring these UEs into CM-CONNECTED mode, the request message comprising an indicator indicating the failure and/or restart of the RAN node; performing a paging procedure for the one or more UEs; and transmitting, to the SMF, a response message for indicating which of the one or more UEs is or are in CM-CONNECTED mode at least based on the result of the paging procedure. In some embodiments, before the step of forwarding the sixth message, the method further comprises: receiving, from the SMF, a request message for querying the one or more UEs that are impacted by the failure and/or restart of the RAN node and/or for requesting the AMF to page the one or more UEs, the request message comprising an indicator indicating the failure and/or restart of the RAN node and/or an ID of the RAN node; determining the one or more UEs at least based on the ID of the RAN node; performing a paging procedure for the determined one or more UEs; and transmitting, to the SMF, a response message comprising the one or more UEs and/or acceptance of paging at least based on the result of the paging procedure.

FIG. 19 is a flow chart of an exemplary method 1900 at an MB-SMF for detecting a failure and/or restart of a RAN node that serves one or more UEs for a multicast session is provided according to an embodiment of the present disclosure. The method 1900 may be performed at a third network node (e.g., the MB-SMF 235 shown in FIG. 2). The method 1900 may comprise step S1910. However, the present disclosure is not limited thereto. In some other embodiments, the method 1900 may comprise more steps, different steps, or any combination thereof. Further the steps of the method 1900 may be performed in a different order than that described herein. Further, in some embodiments, a step in the method 1900 may be split into multiple sub-steps and performed by different entities, and/or multiple steps in the method 1900 may be combined into a single step.

The method 1900 may begin at step S1910 where a message indicating a failure and/or restart of the RAN node may be received from a network node.

In some embodiments, the network node comprises at least one of: an AMF; and an MB-UPF. In some embodiments, the message comprises at least one of: an Nmbsmf_MBSSession_ContextUpdate request message that is transmitted from an AMF for the multicast session; a tenth message for the multicast session, the tenth message being a session report message from an MB-UPF for reporting the failure and/or restart of the RAN node; and an eleventh message for a node level event, the eleventh message being a node report message from an MB-UPF for reporting the failure and/or restart of the RAN node. In some embodiments, the Nmbsmf_MBSSession_ContextUpdate request message indicates at least one of: an ID of the multicast session; and an ID of the RAN node that experienced a restart and/or failure. In some embodiments, the tenth message is a PFCP session report message indicating a TEID and/or an IP address of the RAN node. In some embodiments, the tenth message is a PFCP node report message comprising an IP address pertaining to the failed RAN node.

In some embodiments, before the step of receiving the message, the method further comprises: receiving, from the AMF, a ninth request message requesting for establishing shared delivery toward the RAN node for the multicast session, the ninth request message comprising an ID of the RAN node that is inserted by the AMF and an N2 container provided by the RAN node, the N2 container comprising the ID of the RAN node and further comprising a transport IP address when multicast transport is used or an N3mb tunnel endpoint information when unicast transport is used; configuring the MB-UPF with the transport IP address when multicast transport is used or the N3mb tunnel endpoint information when unicast transport is used, such that the MB-UPF is able to use the transport IP address or the IP address within the N3mb tunnel endpoint indicated by the N3mb tunnel endpoint information to probe the liveness of the RAN node; storing the AMF in a context for the multicast session; and transmitting, to the AMF, a ninth response message indicating whether the shared delivery is established successfully or not and/or indicating information for establishing the shared delivery at least based on a result of the configuring of the MB-UPF.

In some embodiments, after receiving the ninth request message, the method further comprises: establishing a mapping between the ID of the RAN node and a tunnel to the RAN node for the multicast session. In some embodiments, after the step of receiving the message, the method further comprises: determining the tunnel that is impacted by the failure and/or restart of the RAN node at least based on the mapping between the ID of the RAN node and the tunnel; and transmitting, to the MB-UPF, a message for releasing the tunnel.

In some embodiments, the ninth request message is an Nmbsmf_MBSSession_ContextUpdate request message, and the ninth response message is an Nmbsmf_MBSSession_ContextUpdate response message.

FIG. 20 is a flow chart of an exemplary method 2000 at an MB-SMF for restoring a multicast session for one or more UEs that are served by a RAN node experienced a failure and/or restart is provided according to an embodiment of the present disclosure. The method 2000 may be performed at a third network node (e.g., the MB-SMF 235 shown in FIG. 2). The method 2000 may comprise step S2010. However, the present disclosure is not limited thereto. In some other embodiments, the method 2000 may comprise more steps, different steps, or any combination thereof. Further the steps of the method 2000 may be performed in a different order than that described herein. Further, in some embodiments, a step in the method 2000 may be split into multiple sub-steps and performed by different entities, and/or multiple steps in the method 2000 may be combined into a single step.

The method 2000 may begin at step S2010 where it may be triggered to establish relevant resource in the RAN node to receive multicast session data from an MB-UPF for shared delivery, to restore the multicast session for at least one of the one or more UEs, in response to detecting the failure and/or restart of the RAN node.

In some embodiments, the step of triggering the one or more tunnels to be established comprises: transmitting, to an SMF that is associated with the RAN node for the multicast session, a notification message to notify the SMF of the failure and/or restart of the RAN node. In some embodiments, the notification message comprises at least one of: an ID of the RAN node; and an indication of the failure and/or restart of the RAN node. In some embodiments, the failure and/or restart of the RAN node is detected by the MB-SMF with the method of described with reference to FIG. 19.

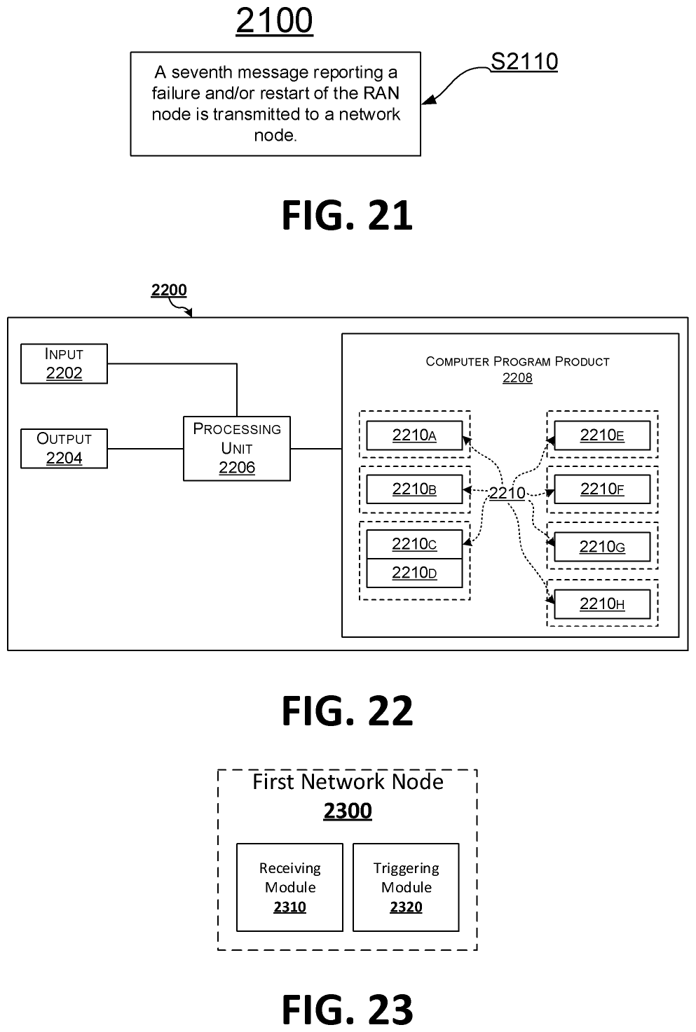

FIG. 21 is a flow chart of an exemplary method 2100 at a RAN node for facilitating a network node in detecting a failure and/or restart of the RAN node that serves one or more UEs for a multicast session is provided according to an embodiment of the present disclosure. The method 2100 may be performed at a RAN node (e.g., the NG-RAN 205 shown in FIG. 2). The method 2100 may comprise step S2110. However, the present disclosure is not limited thereto. In some other embodiments, the method 2100 may comprise more steps, different steps, or any combination thereof. Further the steps of the method 2100 may be performed in a different order than that described herein. Further, in some embodiments, a step in the method 2100 may be split into multiple sub-steps and performed by different entities, and/or multiple steps in the method 2100 may be combined into a single step.

The method 2100 may begin at step S2110 where transmitting, to the network node, a seventh message reporting a failure and/or restart of the RAN node.

In some embodiments, the network node is an AMF. In some embodiments, the seventh message comprises at least one of: an NG Setup request message; and an NG Reset request message. In some embodiments, before the step of receiving the seventh message, the method further comprises: transmitting, to the AMF, an eighth request message requesting for establishing shared delivery toward the RAN node for the multicast session; and receiving, from the AMF, an eighth response message indicating whether the shared delivery is established successfully or not and/or indicating information for establishing the shared delivery. In some embodiments, the method further comprises: joining the multicast transport distribution for the multicast session by using the received information in the eighth response message. In some embodiments, the eighth request message comprises an ID of the RAN node. In some embodiments, the eighth request message is an N2 MBS Session request message, and the eighth response message is an N2 MBS Session response message.

FIG. 22 schematically shows an embodiment of an arrangement which may be used in a network node and/or a RAN node according to an embodiment of the present disclosure. Comprised in the arrangement 2200 are a processing unit 2206, e.g., with a Digital Signal Processor (DSP) or a Central Processing Unit (CPU). The processing unit 2206 may be a single unit or a plurality of units to perform different actions of procedures described herein. The arrangement 2200 may also comprise an input unit 2202 for receiving signals from other entities, and an output unit 2204 for providing signal(s) to other entities. The input unit 2202 and the output unit 2204 may be arranged as an integrated entity or as separate entities.

Furthermore, the arrangement 2200 may comprise at least one computer program product 2208 in the form of a non-volatile or volatile memory, e.g., an Electrically Erasable Programmable Read-Only Memory (EEPROM), a flash memory and/or a hard drive. The computer program product 2208 comprises a computer program 2210, which comprises code/computer readable instructions, which when executed by the processing unit 2206 in the arrangement 2200 causes the arrangement 2200 and/or the network nodes and/or the RAN node in which it is comprised to perform the actions, e.g., of the procedure described earlier in conjunction with FIG. 4 through FIG. 21 or any other variant.

The computer program 2210 may be configured as a computer program code structured in computer program modules 2210A. Hence, in an exemplifying embodiment when the arrangement 2200 is used in a first network node, the code in the computer program of the arrangement 2200 includes: a module 2210A configured to receive, from a network node, a message indicating a failure and/or restart of the RAN node.

The computer program 2210 may be further configured as a computer program code structured in computer program module 2210B. Hence, in an exemplifying embodiment when the arrangement 2200 is used in a first network node, the code in the computer program of the arrangement 2200 includes: a module 2210B configured to trigger establishing relevant resource in the RAN node to receive multicast session data either from a UPF for individual delivery or from a Multicast-Broadcast User Plane Function (MB-UPF) for shared delivery, to restore the multicast session for at least one of the one or more UEs, in response to detecting the failure and/or restart of the RAN node.

The computer program 2210 may be further configured as a computer program code structured in computer program modules 2210C and 2210D. Hence, in an exemplifying embodiment when the arrangement 2200 is used in a second network node, the code in the computer program of the arrangement 2200 includes: a module 2210C configured to receive, from the RAN node, a seventh message reporting a failure and/or restart of the RAN node; and a module 2210D configured to transmit, to the network node, a message indicating the failure and/or restart of the RAN node in response to the received seventh message.

The computer program 2210 may be further configured as a computer program code structured in computer program module 2210E. Hence, in an exemplifying embodiment when the arrangement 2200 is used in a second network node, the code in the computer program of the arrangement 2200 includes: a module 2210E configured to forward a sixth message from the SMF to the RAN node to cause the RAN node to establish relevant resource for receiving multicast session data either from a UPF for individual delivery or from an MB-UPF for shared delivery, to restore the multicast session for at least one of the one or more UEs.

The computer program 2210 may be further configured as a computer program code structured in computer program module 2210F. Hence, in an exemplifying embodiment when the arrangement 2200 is used in a third network node, the code in the computer program of the arrangement 2200 includes: a module 2210F configured to receive, from a network node, a message indicating a failure and/or restart of the RAN node.

The computer program 2210 may be further configured as a computer program code structured in computer program module 2210G. Hence, in an exemplifying embodiment when the arrangement 2200 is used in a third network node, the code in the computer program of the arrangement 2200 includes: a module 2210G configured to trigger establishing relevant resource in the RAN node to receive multicast session data from an MB-UPF for shared delivery, to restore the multicast session for at least one of the one or more UEs, in response to detecting the failure and/or restart of the RAN node.

The computer program 2210 may be further configured as a computer program code structured in computer program module 2210H. Hence, in an exemplifying embodiment when the arrangement 2200 is used in a RAN node, the code in the computer program of the arrangement 2200 includes: a module 2210H configured to transmit, to the network node, a seventh message reporting a failure and/or restart of the RAN node.

The computer program modules could essentially perform the actions of the flow illustrated in FIG. 4 through FIG. 21, to emulate the network nodes and/or the RAN node. In other words, when the different computer program modules are executed in the processing unit 2206, they may correspond to different modules in the network nodes and/or the RAN node.

Although the code means in the embodiments disclosed above in conjunction with FIG. 22 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the network nodes and/or the RAN node.

Correspondingly to the method 1500 and/or the method 1600 as described above, an exemplary first network node is provided. FIG. 23 is a block diagram of a first network node 2300 according to an embodiment of the present disclosure. The first network node 2300 may be, e.g., the SMF 230 in some embodiments.

The first network node 2300 may be configured to perform the method 1500 as described above in connection with FIG. 15. As shown in FIG. 23, the first network node 2300 may comprise a receiving module 2310 configured to receive, from a network node, a message indicating a failure and/or restart of the RAN node. Additionally or alternatively, the first network node 2300 may be configured to perform the method 1600 as described above in connection with FIG. 16. As also shown in FIG. 23, the first network node 2300 may comprise: a triggering module 2320 configured to trigger establishing relevant resource in the RAN node to receive multicast session data either from a UPF for individual delivery or from an MB-UPF for shared delivery, to restore the multicast session for at least one of the one or more UEs, in response to detecting the failure and/or restart of the RAN node.

The above modules 2310 and/or 2320 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 15 and/or FIG. 16. Further, the first network node 2300 may comprise one or more further modules, each of which may perform any of the steps of the method 1500 and/or the method 1600 described with reference to FIG. 15 and/or FIG. 16.

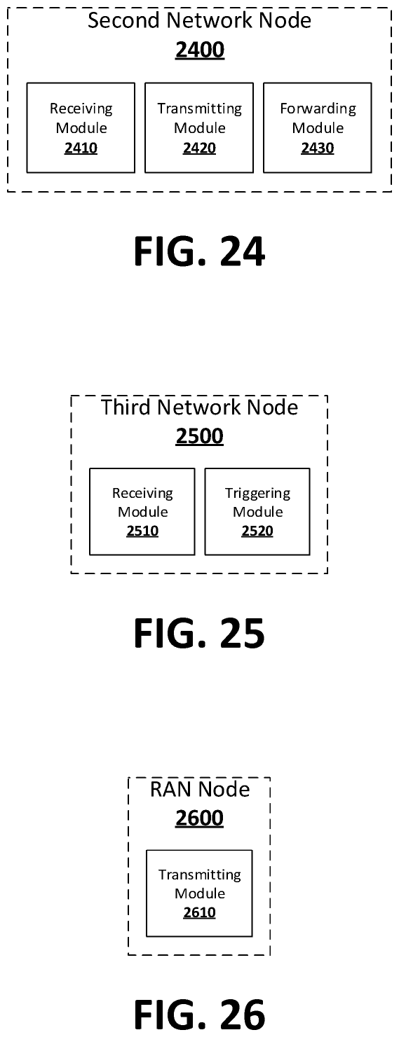

Correspondingly to the method 1700 and/or the method 1800 as described above, an exemplary second network node is provided. FIG. 24 is a block diagram of a second network node 2400 according to an embodiment of the present disclosure. The second network node 2400 may be, e.g., the AMF 225 in some embodiments.

The second network node 2400 may be configured to perform the method 1700 as described above in connection with FIG. 17. As shown in FIG. 24, the second network node 2400 may comprise: a receiving module 2410 configured to receive, from the RAN node, a seventh message reporting a failure and/or restart of the RAN node; and a transmitting module 2420 configured to transmit, to the network node, a message indicating the failure and/or restart of the RAN node in response to the received seventh message. Additionally or alternatively, the second network node 2400 may be configured to perform the method 1800 as described above in connection with FIG. 18. As also shown in FIG. 24, the second network node 2400 may comprise: a forwarding module 2430 configured to forward a sixth message from the SMF to the RAN node to cause the RAN node to establish relevant resource for receiving multicast session data either from a UPF for individual delivery or from an MB-UPF for shared delivery, to restore the multicast session for at least one of the one or more UEs. In some embodiments.

The above modules 2410, 2420, and/or 2430 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 17 and/or FIG. 18. Further, the second network node 2400 may comprise one or more further modules, each of which may perform any of the steps of the method 1700 and/or the method 1800 described with reference to FIG. 17 and/or FIG. 18.

Correspondingly to the method 1900 and/or the method 2000 as described above, an exemplary third network node is provided. FIG. 25 is a block diagram of a third network node 2500 according to an embodiment of the present disclosure. The third network node 2500 may be, e.g., the MB-SMF 235 in some embodiments.

The third network node 2500 may be configured to perform the method 1900 as described above in connection with FIG. 19. As shown in FIG. 25, the third network node 2500 may comprise a receiving module 2510 configured to receive, from a network node, a message indicating a failure and/or restart of the RAN node. Additionally or alternatively, the third network node 2500 may be configured to perform the method 2000 as described above in connection with FIG. 20. As also shown in FIG. 25, the third network node 2500 may comprise: a triggering module 2520 configured to trigger establishing relevant resource in the RAN node to receive multicast session data from an MB-UPF for shared delivery, to restore the multicast session for at least one of the one or more UEs, in response to detecting the failure and/or restart of the RAN node.

The above modules 2510 and/or 2520 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 19 and/or FIG. 20. Further, the first network node 2500 may comprise one or more further modules, each of which may perform any of the steps of the method 1900 and/or the method 2000 described with reference to FIG. 19 and/or FIG. 20.

Correspondingly to the method 2100 as described above, an exemplary RAN node is provided. FIG. 26 is a block diagram of a RAN node 2600 according to an embodiment of the present disclosure. The RAN node 2600 may be, e.g., the NG-RAN 205 in some embodiments.

The RAN node 2600 may be configured to perform the method 2100 as described above in connection with FIG. 21. As shown in FIG. 26, the RAN node 2600 may comprise: a transmitting module 2610 configured to transmit, to the network node, a seventh message reporting a failure and/or restart of the RAN node.

The above module 2610 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 21. Further, the RAN node 2600 may comprise one or more further modules, each of which may perform any of the steps of the method 2100 described with reference to FIG. 21.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| AMF | Access and Mobility Management Function |
| DL | Downlink |
| GTP-U | GPRS Tunnel Protocol - User plane |
| MBS | Multicast/Broadcast Service |
| MB-SMF | Multicast/Broadcast Session Management Function |
| NG-RAN | Next Generation - Radio Access Network |
| SMF | Session Management Function |
| TEID | Tunnel Entity Identity |

1. A method at a Session Management Function (SMF) for restoring a multicast session for one or more User Equipment (UEs) that are served by a Radio Access Network node that experienced a failure and/or, a restart, or both the failure and restart, the method comprising:
receiving, from a network node, a message indicating a RAN node failure and/or a restart of the RAN node;
determining the one or more UEs that joined a multicast session and that are impacted by the failure and/or restart of the RAN node; and
triggering establishing relevant resource in the RAN node via an Access and Mobility Management Function (AMF) to receive multicast session data either from a User Plane Function (UPF) for individual delivery or from a Multicast-Broadcast User Plane Function (MB-UPF) for shared delivery, to restore the multicast session for the impacted one or more UEs, in response to detecting the failure and/or restart of the RAN node.

2. The method of claim 1, wherein the network node comprises at least one of:
an Access & Mobility Management Function (AMF);
a User Plane Function (UPF); and
a Multicast/Broadcast Session Management Function (MB-SMF).

3. The method of claim 1, wherein the message comprises at least one of:
an Nsmf_PDUSession_UpdateSMContext request message that is transmitted from an AMF for a Protocol Data Unit (PDU) session associated with one of the UEs;
a first message for one or more UEs, one or more PDU sessions, or both one or more UEs and one or more PDU sessions (one or more UEs and/or one or more PDU sessions), the first message being a request message transmitted from an AMF for requesting for a service operation provided by a Session Management Function (SMF) that is not defined in 3^{rd} Generation Partnership Project (3GPP) Technical Specification (TS) 23.502, V17.3.0 or any of its prior releases;
a second message for a list of one or more UEs and/or a list of one or more PDU sessions, the second message being an event notifying message from an AMF for notifying the SMF of an event of a failure and/or restart of the RAN node;
a third message for a PDU session, the third message being a session report message from a UPF for reporting the failure and/or restart of the RAN node;
a fourth message for a node level event, the fourth message being a node report message from a UPF for reporting the failure and/or restart of the RAN node; and
a fifth message for the multicast session, the fifth message being transmitted from an Multicast/Broadcast Session Management Function (MB-SMF) associated with the multicast session.

4. The method of claim 3, wherein the first message indicates one of:
a single UE and/or a single PDU session that are impacted by the failure and/or restart of the RAN node; and
a list of one or more UEs and/or a list of one or more PDU sessions that are impacted by the failure and/or restart of the RAN node.

5. The method of claim 3 or 4, wherein the second message indicates one of:
a Communication-Failure-Report event; and
an AMF event that is not defined in the 3GPP TS 23.502, V17.3.0 or any of its prior releases, or 3GPP TS 29.518 V17.4.0 or any of its prior releases.

6. The method of claim 3, wherein when the message comprises the second message, the method further comprises, before the step of receiving of the message:
transmitting, to the AMF, a message for subscribing the event.

7. The method of claim 6, wherein the message for subscribing the event comprises at least one of:
Identifiers (IDs) of one or more of the UEs or an “any UE” indication;
one or more area identifiers;
Network Function (NF) service consumer service instance ID; and
authority of resource Uniform Resource Identifier (URI).

8. The method of claim 3, wherein the event comprises at least one of:
a RAN/Non-Access Stratum (NAS) release code;
one or more UE Identifiers (IDs);
one or more PDU session IDs; and
an NG-RAN restart or failure indication.

9. The method of claim 1, wherein thestep of determining the one or more UEs comprises at least one of:
determining the one or more UEs that are indicated in a received message from the AMF, the received message further indicating the failure and/or restart of the RAN node; and
retrieving one or more UEs which have a same Internet Protocol (IP) address in their tunnel endpoint for a downlink tunnel in the RAN node to receive multicast session data when the RAN failure or restart is reported by the UPF.

10. The method of claim 1, wherein before the step of triggering establishing the relevant resource in the RAN node, the method further comprises:
receiving, from an Multicast/Broadcast Session Management Function (MB-SMF), a fifth message indicating a detected failure and/or restart of the RAN node and an Identifier (ID) of the RAN node;
transmitting, to a Network Repository Function (NRF), a request message to discover a list of AMFs having association with the RAN node;
receiving, from the NRF, a response message containing a list of AMFs;
selecting an AMF from the list of AMFs;
transmitting, to the AMF, a request message for querying the one or more UEs that are impacted by the failure and/or restart of the RAN node, for requesting AMF to page the one or more UEs, or both for the querying the one or more UEs that are impacted by the failure and/or restart of the RAN node and for the requesting AMF to page the one or more UEs, wherein the request message comprising an indicator indicating the failure and/or restart of the RAN node, an ID of the RAN node, or both the indicator indicating the failure and/or restart of the RAN node and the indicator indicating the failure and/or restart of the RAN node; and
receiving, from the AMF, a response message comprising the one or more UEs, acceptance of paging, or both the one or more UEs and the acceptance of paging.

11. An SMF for restoring a multicast session for one or more User Equipment (UEs) that are served by a Radio Access Network (RAN) node that experienced a failure, a restart, or both the failure and restart (failure and/or restart), comprising:
a processor;
a memory storing instructions which, when executed by the processor, cause the processor to:
receive, from a network node, a message indicating a RAN node failure and/or a restart of the RAN node;
determine the one or more UEs that joined a multicast session and that are impacted by the failure and/or restart of the RAN node; and
trigger establishing relevant resource in the RAN node via an Access and Mobility Management Function (AMF) to receive multicast session data either from a UPF for individual delivery or from a Multicast-Broadcast User Plane Function (MB-UPF) for shared delivery, to restore the multicast session for the impacted one or more UEs, in response to detecting the failure and/or restart of the RAN node.

12. A method at an Access and Mobility Management Function (AMF) for facilitating a network node in detecting a failure, and/or a restart, or both the failure and restart (failure and/or restart), of a Radio Access Network (RAN) node that serves one or more User Equipment (UEs) for a multicast session, the method comprising:
receiving, from the RAN node, a-seventh message reporting a failure and/or restart of the RAN node; and
transmitting, to the network node, a message indicating the failure and/or restart of the RAN node in response to the received-seventh message.

13. The method of claim 12, wherein the network node comprises at least one of:
an Session Management Function (SMF); and
an Multicast/Broadcast Session Management Function (MB-SMF).

14. The method of claim 12, wherein the message comprises at least one of:
an Nmbsmf_MBSSession_ContextUpdate request message that is transmitted to an Multicast/Broadcast Session Management Function (MB-SMF) for the multicast session;
an Nsmf_PDUSession_UpdateSMContext request message that is transmitted to an Session Management Function (SMF) for a Protocol Data Unit (PDU) session associated with one of the UEs;
a first message for one or more UEs, one or more PDU sessions, or both one or more UEs and one or more PDU sessions (one or more UEs and/or one or more PDU sessions), the first message being a request message transmitted to an SMF for requesting for a service operation provided by the SMF that is not defined in 3GPP TS 23.502, V17.3.0 or any of its prior releases; and
a second message for a list of one or more UEs and/or a list of one or more PDU sessions, the second message being an event notifying message from an Access and Mobility Management Function (AMF) to an SMF for notifying the SMF of a failure and/or restart event of the RAN node.

15. The method of claim 14, wherein the Nmbsmf_MBSSession_ContextUpdate request message indicates at least one of:
an Identifier (ID) of the multicast session; and
an ID of the RAN node that experienced a restart and/or failure.

16. The method of claim 14, wherein the first message indicates one of:
a single UE, a single PDU session, or the single UE and the single PDU session, that are impacted by the failure and/or restart of the RAN node; and
a list of one or more UEs and/or a list of one or more PDU sessions that are impacted by the failure and/or restart of the RAN node.

17. The method of claim 14, wherein the second message indicates one of:
a Communication-Failure-Report event; and
an AMF event that is not defined in the 3GPP TS 23.502, V17.3.0 or any of its prior releases, or 3GPP TS 29.518 V17.4.0 or any of its prior releases.

18. The method of claim 14, wherein when the message comprises the second message, the method further comprises, before the transmitting of the message:
receiving, from the SMF, a message for subscribing the event,
wherein before the transmitting of the message, the method further comprises determining the SMF as a destination, which is to be notified of the event, at least based on the received message for subscribing the event.

19. (canceled)

20. The method of claim 14, wherein the event comprises at least one of:
a RAN/Non-Access Stratum (NAS) release code;
one or more UE Identifiers (IDs);
one or more PDU session IDs; and
an NG-RAN restart or failure indication.

21. An Access and Mobility Management Function (AMF) for facilitating a network node in detecting a failure, a restart, or both the failure and restart (failure and/or restart), of a Radio Access Network (RAN) node that serves one or more User Equipment (UEs) for a multicast session, comprising:
a processor;
a memory storing instructions which, when executed by the processor, cause the processor to:
receive, from the RAN node, a message reporting a failure and/or restart of the RAN node; and
transmit, to the network node, a message indicating the failure and/or restart of the RAN node in response to the received message.

22-34. (canceled)
